(19) United States
(12) Patent Application Publication
(10) Pub. No.: US 2016/0072291 A1
(43) Pub. Date: Mar. 10, 2016

(54) ENERGY PROCESSING AND STORAGE

(71) Applicant: MADA ENERGIE LTD, Jerusalem (IL)

(72) Inventor: Arnold J. GOLDMAN, Jerusalem (IL)

(21) Appl. No.: 14/786,969

(22) PCT Filed: Apr. 25, 2014
(86) PCT No.: PCT/IB2014/001422

§ 371 Date: Oct. 23, 2015

Related U.S. Application Data
(60) Provisional application No. 61/854,493, filed on Apr. 25, 2013.
(60) Provisional application No. 61/817,149, filed on Apr. 29, 2013.
(60) Provisional application No. 61/819,992, filed on May 6, 2013.
(60) Provisional application No. 61/836,470, filed on Jun. 18, 2013.
(60) Provisional application No. 61/898,093, filed on Oct. 31, 2013.

(51) Int. Cl. H02J 3/38; G05B 19/042; G05B 19/10

(52) U.S. Cl. CPC H02J 3/382; H02J 3/383; H02J 3/386; G05B 19/102; G05B 19/042; G05B 2219/2639

(57) ABSTRACT

Systems, methods, devices and apparatus for operating an energy system that can include an energy storage system.

### RELATED APPLICATIONS

The present application claims the benefit of U.S. Provisional Application Nos. 61/854,493, 61/817,149, 61/819,992, 61/836,470, and 61/898,093, filed Apr. 25, 2013, Apr. 29, 2013, May 6, 2013, Jun. 18, 2013, and Oct. 31, 2013, respectively, each of which is hereby incorporated by reference herein in its entirety.

### FIELD

Embodiments of the present invention relate generally to energy processing and storage. More specifically, embodiments relate to controlling, storing, and distributing power from and/or to an electric grid.

### BACKGROUND

Numerous problems plague electricity systems that rely on various sources of energy. Problems may arise from some fossil fuel power plants and other energy sources that are difficult to cycle down and/or turn off electrical energy output when demand is low and may result in overcapacity on the grid that may lead to waste or curtailed energy. Problems such as intermittency of, for example renewable energy sources such as wind energy farms, photovoltaic solar plants and/or other sources of renewable energy make these sources unreliable and may require a solution such as a storage source for energy. A rising demand for more power which may require more energy capacity which may be provided by building new facilities, which in turn may increase the problems stated above. There is also a growing demand in some specific local regions for cleaner and greener energy sources.

Some of the technologies that may be used in some specific regional grids for backup, storage, balancing, stabilizing, firming etc. may be charged and discharged. Charging may occur at the peak of the intermittency, power surplus, low electricity prices, etc. and the discharge may occur at the trough, power deficiency, high electricity prices, etc. Technologies such as Pumped Hydro Storage (PHS), Comprised Air Energy Storage (CASE) and/or batteries are examples of technologies that can be charged. These technologies suffer from difficulties such as, for example, the need for a specific topographical unit that many times is not available in a region that suffers from intermittent energy. Batteries suffer from difficulties such as, for example, cost issues, and danger hazards.

Single cycle turbines are another backup technology for intermittent energy which can produce power at needed times, but may suffer efficiency loss when turned on and off and/or cycled down and up. This efficiency loss may cause an increase in NOx as well as price. Single cycle turbines can fill in the gaps of intermittent energy but may not have the ability to draw down power when needed, thus may not average out the electrical energy capacity if and/or when needed.

In the field of electrical energy storage, energy shifting, TOD shifting, grid stabilizing etc. efficiency may be a key matrix, due to the fact that some form of energy is consumed in order to generate the same or different form of energy at the same or different time. As a process, apparatus, method etc. is more efficient, that process, apparatus, method etc. may become more desirable, cost effective, clean, reducing emissions etc.

Further, in the field of energy storage, energy shifting TOD shifting, grid stabilizing etc., cost and efficiency can be key factors in deciding on the desired apparatus.

Flexibility in the electrical energy field is becoming more desirable. There may be many reasons for this growing need and/or desire for flexible and dispatchable facilities, whereas some of these reasons may involve the increasing introduction of more renewable energy to some electrical grid regions. Renewable energy sources that are being introduced into the electrical grid may have the characteristic of being unstable as known to one who is skilled in the art. The unstable renewable energy sources may provide large electrical energy capacity at one point of time and may provide small or no electrical energy capacity at a different point of time. This may be easily understood by an example of solar energy, wherein the sun shines for only part of the day. The same issues may arise with wind power. The introduction of renewable energy may be one of many reasons for the need of flexible electrical energy facilities. The electrical grid's stability may shift from one electrical grid region to the other, which may cause some region to need or desire flexible energy facilities more or less than other regional electrical grids.

An unstable electrical grid (i.e. an electrical grid that may suffer from electrical capacity shifts from one point of time to another) may find flexible and highly dispatchable electrical energy generations facilities as useful and desirable. It may be the case that the desire for flexible power generating facilities may include the response time of the dispatching facility, i.e. the amount of time that a given power generator could dispatch, stop dispatching and/or draw down electrical energy to and from the electrical grid. It may be the case that some systems may desire a fast response, wherein a fast response may be measured in seconds or fractions of a second, whereas other facilities may desire a long dispatch period which may be a response times measured in minutes.

Facilities of different nature may differ in their flexibility characteristics. As known to one skilled in the art, a coal power plant is less dispatchable (fixable) then a simple cycle gas turbine. However it may be the case that even a highly dispatchable facility such as a simple cycle gas turbine would suffer from the need to cycle up and down its rotating equipment. Thus the ramp rate of a said simple cycle gas turbine may need to account for the time to cycle up its rotating equipment to full load.

One technology that may have fast response time, may be batteries or capacitors. Batteries or capacitors (“batteries”) may respond in a matter of seconds or fractions of seconds and may provide needed auxiliary services such as fast responding power dispatching facilities. In this regard batteries may provide a suitable solution for the need of a fast response. However batteries may suffer from cost issues which may be related to scaling costs. In many technologies scaling up the energy storage capacity of the facility may result in a disproportionate low scaling of cost. For example, once the storage capacity is in place, the system may have a relatively small cost impact that may amount to perhaps some tens of percent and may result in doubling the storage capacity. Whereas traditional (non-flow) batteries may have linear or close to linear storage capacity scaling up costs. For example, the scaling of a traditional battery's storage capacity by a factor of two may result in approximately doubling the cost.

Further, the batteries have cycle life times which are relatively short compared to that of traditional power generation equipment. As a result this requires costly battery replacements during the life time of the facility. Whereas the rotating power storage systems may have life time which are very comparable with the 30 to 60 year life time of traditional power generation equipment.

### SUMMARY

Electrical energy may be generated utilizing the changing features of the working fluid when it flows from cryogenic forms and/or temperatures to non-cryogenic forms and/or temperatures. The capacity of electrical energy generation increases as the delta between the low temperatures of the working fluid and the high temperatures of the working fluid increase.

Efficiency in processes such as those stated above is a key factor to the process. In processes such as stated above, energy may be consumed during one period of time, stored and then generated back during a second period of time. Although there may be many fields in which the process contains a working fluid shifting from cryogenic forms and/or temperatures and vice versa, embodiments of the present disclosure are directed towards the field of electrical generation in general and, more specifically, towards electrical energy storage. Some embodiments are further directed to Time of Day (TOD) delivery.

According to some embodiments, a power storage and/or generation facility integrates rotating equipment (e.g. a LAES) with an electrical storage unit (e.g. a battery) to improve the ramp up and ramp down time. Improving the ramp up and down may refer to shortening the total response time of the facility, enabling and improved response time of the combined system with very modest increases in the cost of the combined system.

This combination of capabilities enable the facility to both have a fraction of a second response time, and at the same time being able to provide low cost large scale storage capacity compared to battery systems.

The renewable power generating facility may be, for example, a wind power facility, Concentrated Solar Power (CSP), Photovoltaic (PV), or other renewable sources. It may be the case that renewable energy may suffer from a number of power distribution issues. Three of such issues may be (i) the period of time in which the power is dispatched to the electrical grid, (ii) the reliability of power supply, and (iii) the supply of intermittent power to the grid. One who is skilled in the art will know that each one of the above stated issues may result in a reduction of the value of the supplied power.

### BRIEF DESCRIPTION OF THE DRAWINGS

Embodiments will hereinafter be described in detail below with reference to the accompanying drawings, wherein like reference numerals represent like elements. The accompanying drawings have not necessarily been drawn to scale. Any values illustrated in the accompanying graphs and figures are for illustration purposes only and may not represent actual or preferred values. Where applicable, some features may not be illustrated to assist in the description of underlying features.

FIG. 1A is a block diagram of a system according to one or more embodiments of the disclosed subject matter.

FIG. 1B illustrates a storage system comprising a Liquid Air Energy Storage (LAES) facility, which may operate in conjunction with an electrical storage unit, according to one or more embodiments of the disclosed subject matter.

FIG. 2 is a block diagram of a front end system that may receive data from multiple sources that can include but not limited to, control data or detector data according to one or more embodiments of the disclosed subject matter.

FIG. 3 is a block diagram of a number of cases that could be addressed by the system according to one or more embodiments of the disclosed subject matter.

FIG. 4 illustrates a block diagram of a case when the control system sends a command to configure the system to achieve desirable mode of operation, which may address a state of overcapacity on the grid according to one or more embodiments of the disclosed subject matter.

FIG. 5A illustrates a block diagram of a case when the control system sends a command to configure the system to achieve desirable mode of operation, which may address a state of intermittent energy on the grid according to one or more embodiments of the disclosed subject matter.

FIG. 5B is a flow diagram illustrating a method of controlling the system to achieve a desirable mode of operation during a state of intermittent demand/supply of energy on the grid, according to one or more embodiments of the disclosed subject matter.

FIG. 5C is a flow diagram illustrating a method of controlling the system to achieve a desirable mode of operation during a state of intermittent demand/supply of energy on the grid, according to one or more embodiments of the disclosed subject matter.

FIG. 6 illustrates a block diagram of a case when the control system sends a command to configure the system to achieve desirable mode of operation, which may address a state of needed capacity on to the grid according to one or more embodiments of the disclosed subject matter.

FIG. 7 illustrates a case when the control system sends a command to configure the system to supply scheduled energy capacity on the grid according to one or more embodiments of the disclosed subject matter.

FIG. 8 illustrates a block diagram of a case when the control system sends a command to configure the system to achieve desirable mode of operation, which may address a state where energy capacity is equal to demand according to one or more embodiments of the disclosed subject matter.

FIG. 9A illustrates a high frequency intermittent energy capacity graph shifting from peak to trough rapidly from minute to minute according to one or more embodiments of the disclosed subject matter, and

FIG. 9B illustrates a low frequency intermittent energy capacity graph shifting from peak to trough in prolonged time according to one or more embodiments of the disclosed subject matter.

FIG. 10 illustrates a system containing a storage system with multiple devices and apparatuses in conjunction with a renewable energy power generating facility, according to one or more embodiments of the disclosed subject matter.

### DETAILED DESCRIPTION

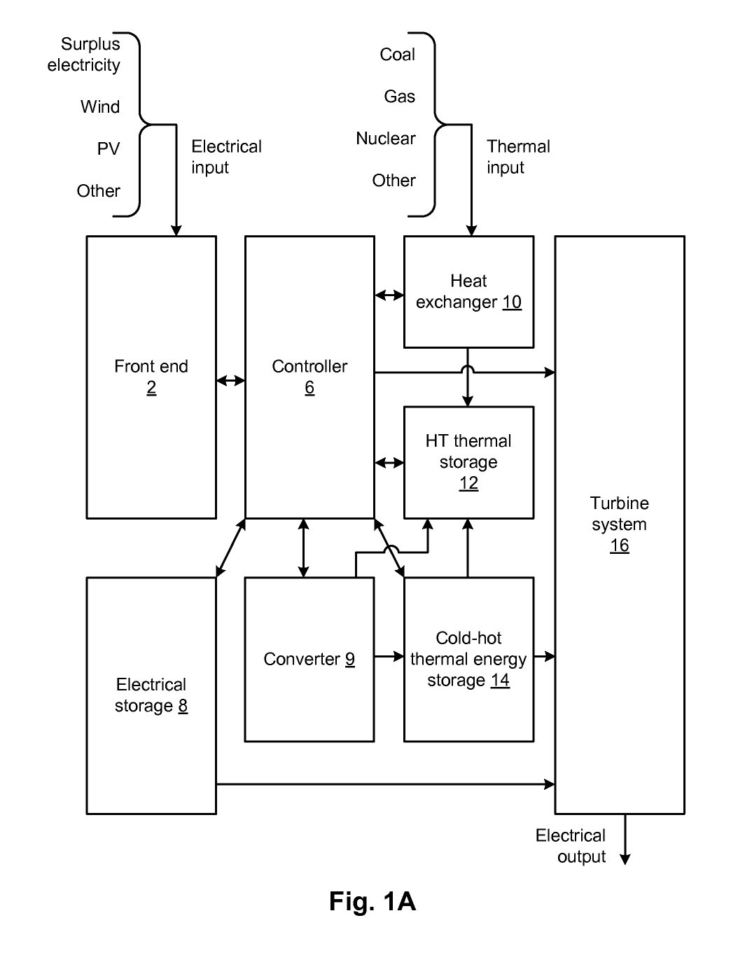

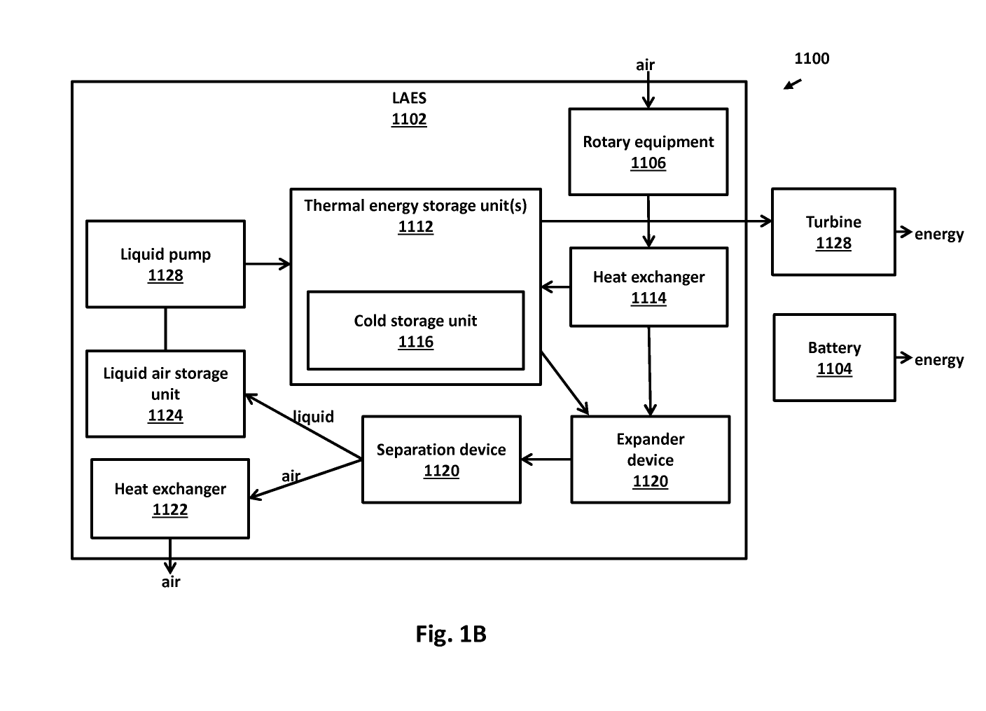

FIG. 1 illustrates a system 1 that can ameliorate many problems with integration of the grid with renewable energy and other sources of energy and to address load leveling and tariff shifting opportunities. A basic schematic of the systems discussed herein, according to embodiments, is system 1 which includes a front end system 2, a controller 6, an electrical storage 8, a converter 9, a heat exchanger 10, a high temperature thermal storage 12, a cold-hot thermal storage 14, and a turbine system 16.

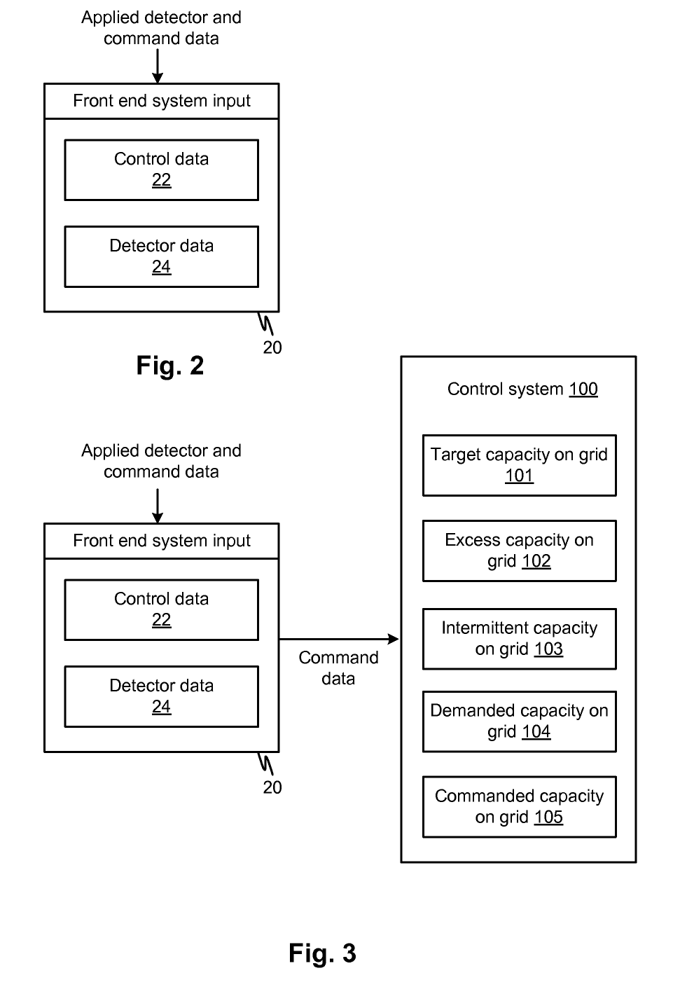

The front end system 2 processes real time data including command data from an operator or control agent computer and sensor data as well as data representing external conditions such as weather forecasts, output of computer models that predict load and supply from a grid or energy suppliers, and other data. The data that is processed by front end system 2 may include, for example, control data 22 shown in FIG. 2 (i.e., data that system operators input into the system), and/or detector data 24 shown in FIG. 2 (i.e., data that the system detects from the grid, from the system, and/or from the environment and other sources of data that may change at any moment). This data is processed by sets of algorithms in order to detect the problem on the grid. When a predefined state is detected (identified), front end system 2 may send data and/or one or more commands to control system 6 instructing it to configure system 1 in order to achieve a target outcome.

A target outcome can be achieved by different configurations of system 1. For example, system 1 may be configured to draw down and store energy from the grid (e.g., by converting electrical input to thermal energy that can be stored in one or more thermal storage units such as high temp thermal storage 12 and/or cold-hot thermal storage 14). System 1 can also be configured to store energy from the grid by converting electrical input to electrical storage and storing it in an electrical storage unit such as electrical storage 8. When power is needed on to the grid, system 1 may discharge the stored energy by converting the thermal energy to electrical energy and/or by discharging the electrical storage to the grid.

In some embodiments, front end system 2 may receive data on or about the grid (or any other generator) or sense/detect data directly from the grid or receive data from the network managers, from smart grids and equivalent etc. In such embodiments, front end system 2 may receive and send data to a controller unit, such as controller 6. Data that was detected or commands that were received by front end system 2 may be sent to controller 6. This data may then be decoded, analyzed, go through algorithm sets etc., and/or be transformed. For example, controller 6 may transform received data or commands into further commands or sets of commands. These commands may configure system 1 (and/or the facility, apparatuses etc., connected to system 1) in order to reach a target outcome from, for example, system 1.

In some embodiments, controller 6 may analyze data received from front end system 2 and process the data by sets of algorithms. Among other algorithms controller 6 may perform algorithms relating to needs of system 1 such as, for example, supplementing electrical energy that is determined by conditions and/or characteristics external and/or internal to system 1 and algorithms that are external and/or internal to system 1.

In some embodiments, controller 6 may also be configured to receive status reports from different units within the system and may send reports to front end system 2.

The functionality of both front end system 2 and controller 6 may change, in accordance to different configurations, settings, response time, needs etc. Functions may be set and programmed in one or more components. Embodiments of the description describe a case in which unit 2 functions as a front end system and function as stated above; unit 6 functions as a controller and functions as stated above. But these units and/or functions may vary and change their function individually and/or change their function in relation to one another.

In some embodiments, controller 6 sends data and/or commands to electrical storage unit 8. Additionally or alternatively, in some embodiments, controller 6 receives data and/or commands from electrical storage unit 8. According to one or more embodiments of the disclosed subject matter electrical storage unit 8 can consume electrical energy from the grid (or any other generator) and by doing so electrical storage unit 8 can charge its electrical storage. According to one or more embodiments of the disclosed subject matter electrical storage unit 8 can generate electrical energy to the grid (or any other consumer) by discharging the stored electricity in electrical storage unit 8. The electrical storage unit 8 may be charged by the system, and may discharge electrical energy to the system. Charging electrical storage unit 8 can be performed by an electrical input to an electrical storage conversion system such as, for example, converter 9, in some embodiments. Discharging electrical storage unit 8 can be performed by electric storage to a line output conversion system such as, for example, turbine system 16, in some embodiments.

It will be appreciated that terms such as battery and supercapacitor are used interchangeably herein and may mean any electrical storage system. Also these and any other examples can be substituted, for example where a battery is mentioned, a flywheel energy store or compressed air energy storage could be used.

In embodiments, controller 6 generates and sends data and/or commands to a unit such as, for example, converter 9, that, in some such embodiments, contains a set of configured devices that are assembled and/or configured to convert electrical energy input into thermal energy. In some embodiments, controller 6 may receive commands to convert all or a portion of electrical energy into stored thermal energy. In some embodiments, during the process of converting electrical energy to thermal energy via converter 9, a low temperature thermal energy can be generated, a high temperature thermal energy can be generated, and/or both low and high temperatures thermal energy can be generated. In some embodiments, converter 9 converts electrical energy into low and high thermal energy temperatures by, for example, assembling means that are or resemble the functions of a heat pump. In some such embodiments, these means may include components such as, for example, a motor, compressor, expander etc. within which a working gas or fluid may flow from one device to another with the needed conduits. In some embodiments, a motor may power a compressor that may compress air, or any other gas into converter 9. Although the following describes air as the working fluid, it is clear that air is only an example and any other suitable gas may be used. The working fluid may be in the form of gas or liquid in accordance to the state in which it is in. The temperature and pressure of the air may increase as a result of being compressed. In some embodiments, the high temperature air may exchange heat with a suitable storage material located within the hot unit of cold-hot thermal storage unit 14 and the thermal energy can be stored in the storage material. In some examples, the thermal energy is transferred via at least one heat exchanger. Additionally or alternatively, the working fluid can flow through a storage material such as gravel. Examples of storage materials may include but is not limited to molten salt and/or molten metal, pressurized water, oils, gravel, propane etc. The material in which the thermal energy may be stored can be a hot liquid and/or a solid storage media such as, for example, cement, rocks, gravel, ceramic storage material etc. In some embodiments, this material is stored in the high temperature section within cold-hot thermal energy storage 14. The process of extracting heat from the working fluid can be performed one or more times. Following extracting heat from the working fluid, converter 9 can reduce the temperature of the fluid to a cryogenic level transforming it into a liquid state. In some embodiments, the low temperature liquid working fluid is stored in the cold section of the cold-hot thermal storage unit 14. In some such embodiments, when the system 1 performs energy generation it can pump a liquid working fluid (which may be air) from the low temperature section of the cold-hot storage unit 14 to a higher (e.g., the highest) temperature unit in the system 1. In some embodiments, it may be pumped to the high temperature section of the cold-hot unit 14 and/or to the high temperature in the high temperature thermal storage 12. In some embodiments, the working fluid is converted into a high temperature working fluid that may enter into a turbine which may be located in and/or associated with turbine system 16 and thereby drive the turbine.

In embodiments, when air enters into the system 1 through the compressor and is cooled through various apparatus and enters into the liquid stage, the air is separated into one or more various components such as Nitrogen, Oxygen, Argon etc. producing commercial industrial gas products that may have value, and could be sold as a byproduct or used within the system.

In some such embodiments, having O₂ available as a separated gas in the system 1 allows the circulated air to be burned in an Enhance Oxygen Combustion (EOC) environment. For example, when the percentage of oxygen burned increases from the natural content in the air, which is approximately 21% to approximately 35%, it may increase the capacity of a turbine considerably thereby, increasing the potential power produced by the turbine.

In some embodiments, having cryogenically cooled liquids in large volumes allows the cryogenically cooled liquids to be used to operate superconductors in various applications. For example, superconductors may operate within the system namely in the transformers and/or motor and/or generator and/or the storage device. The use of superconductors in these applications can contribute to the overall energy efficiency of the system.

According to some embodiments, converter 9 can generate thermal energy from one or more separate configuration or separate systems, operating systems, devices, technologies, configurations etc. not shown in FIG. 1. Additionally or alternatively, one or more systems, operating systems, devices, technologies, configuration etc. can generate low and high temperature thermal energy. Additionally or alternatively, one or more systems, operating systems, devices, technologies, configurations can generate hot temperature thermal energy. In some embodiments, controller 6 can be configured to operate one or more systems, operating systems, devices, technologies, configuration etc. to generate (i) low and high temperature thermal energy, (ii) high temperature thermal energy (i.e. high temperature thermal energy without low temperature thermal energy) or (iii) both low and high temperature thermal energy and high temperature thermal energy. Furthermore, the electrical energy being converted may be supplied from the grid, or any other generator (which may include the system itself)

According to one or more embodiments of the disclosed subject matter, thermal energy that has been generated by converting electricity to thermal energy is stored in one or more thermal energy storage unit units such as, for example, cold-hot thermal storage 14 and high temperature thermal storage 12. There may be one or more thermal energy storage units wherein one thermal energy storage unit may contain storage units for low thermal energy temperatures and for high thermal energy temperatures (e.g., cold-hot thermal energy storage 14). The low and high thermal energy temperatures may be stored in separate units within a single unit. The low and high thermal energy temperatures storage units may be separated from one another, but may be interconnected by suitable conduits in such a way that may allow one or more working material/fluids or storage materials to flow from one to another. The storage unit that contains both low and high thermal energy temperatures may be referred to as cold-hot thermal storage unit 14. Embodiments can include one or more cold-hot thermal storage units 14. The cold-hot unit may receive data and/or orders/instructions/commands from controller 6 and/or from converter 9. According to some embodiments, the storage material used in cold-hot thermal storage unit 14 may the same or different than the storage material used in high temperature thermal storage 12.

In some embodiments, cold-hot thermal storage unit 14 may store thermal energy that is cold and hot, and this unit may be charged (i.e. storing cold and hot thermal energy) by converting electrical energy from the grid, any other generator, or from the system 1 itself.

In some embodiments, there may be another thermal energy storage unit that can contain high temperature thermal energy, such as, for example, high temperature thermal storage unit (or “hot unit”) 12. Embodiments can include one or more hot units 12.

In some embodiments, high temperature thermal storage 12 is interconnected to the cold-hot unit 14 in such a way that one or more working materials/fluids may flow from the cold-hot unit 14 to the hot unit 12. The high temperature in the hot unit 12 may be higher than the high temperature in the cold-hot unit 14. In some embodiments, the size of the hot unit is limited by a cap. In some such embodiments, the cap can be defined as a percentage of the total thermal energy that is stored in the entire system.

In some embodiments, controller 6 monitors and/or controls the amount of energy that is being generated for and stored in the cold-hot unit 14 and/or the hot unit 12, thereby maintaining a balance of the system.

In some embodiments, the hot unit 12 may be charged (i.e. storing high temperature thermal energy) by converting electrical energy via converter 9 from the grid, from another source, or from the system 1 itself. Alternatively or additionally, the hot unit 12 may be charged by converting heat to thermal energy via one or more devices such as heat exchanger 10 and may be stored. Heat may be generated, for example, by combusting fuel or from a nuclear source or any other heat generating source as thermal input and may be converted to thermal energy that may be stored via heat exchanger 10. In certain embodiments, high temperature thermal storage 12 may be charged from both methods together. The thermal input heat may be converted by a unit that contains a set of configured devices that are assembled in such a way that may convert heat in to thermal energy that may be stored (e.g. heat exchangers such as heat exchanger 10).

In some embodiments, high temperature thermal storage 12 receives data and/or commands from controller 6 and/or from converter 9.

In some embodiments, the system 1 generates electrical energy and/or generates steam. In some such embodiments, this is performed via turbine system 16 that, in some embodiments, comprises a set of configured devices that are assembled in such a way to convert thermal energy to electrical energy or to steam, or to both. Additionally or alternatively, in some embodiments, turbine system 16 also generates electrical energy or steam by discharging the electrical storage.

According to some embodiments, when there is excess capacity on the grid, the system 1 may absorb (e.g. store) the excess capacity which may solve issues of curtailment that are typical to a few sources including but not limited to night energy, wind energy, PV and others 50. At the same time the system 1 can store thermal energy that is being produced from coal, gas, nuclear and/or other thermal input (that cannot or are typically not shut down or are difficult to cycle down) using heat to thermal storage heat exchanger 10 which may then be stored in the thermal storage unit 12 until the time that it is needed.

In some embodiments comprising thermal based energy generation systems, the system becomes both more efficient and the generation capacity of the system increases for a given amount of fuel used when the heat to electrical conversion equipment is working at higher temperatures. In some examples, these systems or equipment for such systems may include, for example, cycle gas turbines, combined cycle gas-steam turbines, and steam turbines (for fossil fuel systems).

In some embodiments system 1 is a storage system that stores energy in a thermal form. In some embodiments, a portion of the energy that is stored in the system 1 is produced by a heat pump apparatus or an apparatus that functions as a heat pump apparatus. In such embodiments, the heat pump can compress ambient air, for example, and the heat from the compressed air may be extracted from the air and stored within suitable storage materials and/or vessels for later use. After heat is extracted from the compressed air, the air may be processed and reduced to liquid air and/or one or more liquid air components. The liquid air and the stored heat from the air compression may be stored for later use. At a time when electrical energy is needed, the liquid air may be pumped through heat storage units and then passed into a turbine generator to generate electricity.

In some embodiments, in order to maximize the efficiency and thereby increase the delta temperature between the highest and lowest temperature, the air is compressed a significant amount to generate high temperature heat derived from the compression. Such high temperature heat could be used for later reheating the air returning from its liquid state, thereby increasing its temperature as well as increasing the resulting potential efficiency in the electrical generation cycle.

In one embodiment of the disclosed matter, during a first operating period, controller 6 may send data and/or a command to charge the high temperature thermal energy storage 12. The charging can be performed by converting electrical energy to thermal energy using converter 9. Converter 9 may contain means, devices, flow direction etc. to convert electrical energy to thermal energy that may be stored in the high temperature thermal energy storage unit 12. Such means may be or function as heating coils, or any other means, devices, flow direction etc. that may function as a heating coil to convert electrical energy to thermal energy. The high temperature thermal energy storage unit 12 may be charged by storing input heat generated from combusting a fossil fuel such as coal, gas etc. or generated from a nuclear plant or any other heat generator 200. Heat may be converted and transferred to the storage media through any number of means which one skilled in the art familiar with combustion systems, burners, and heat exchanges are familiar with. In some embodiments, the process of exchanging heat from the input heat source to the high temperature thermal energy storage 12 may be via heat exchanger 10. Charging the high temperature thermal energy storage unit 12 may be done by one or both methods (i.e. electrical to thermal and/or input heat to thermal storage) and may be charged by a single method and not require both methods. In some embodiments, the thermal energy stored within the high temperature thermal energy storage unit 12 would be of a higher temperature than the temperature of the thermal energy contained within the hot unit of the cold-hot thermal energy storage 14.

In one embodiment of the disclosed matter, during a second operating period, controller 6 may send data and/or a command to discharge the system and generate electrical energy. The cryogenic working fluid that may be liquid air, stored in the cold-hot thermal storage unit 14 may be pumped through the hot unit of the cold-hot thermal unit 14. In the event where a high temperature thermal storage 12 exists and is available, the working fluid may then flow through the high temperature thermal storage 12. The hot working fluid may flow from high temperature thermal energy storage unit 12 and drive a turbine 16 in order to generate electrical energy. The process of converting thermal energy to electrical energy 300 may be located or associated to turbine 16.

In one embodiment of the disclosed matter, the thermal energy that is exchanged to the working fluid may be controlled and/or altered in order to meet different needs of system 1.

According to one embodiment, system 1 is an apparatus containing two thermal energy storage units. Whereas the first thermal storage unit (e.g. cold-hot thermal unit 14) may be a cold-hot unit, and may contain the means to generate both low temperatures that may be in the field and terms of cryogenic energy, and the second thermal storage unit (e.g., high temperature thermal unit 14) may contain material with relatively high thermal energy temperatures. Both units may be charged by processing a working fluid that may be air. In both cases, the thermal energy may be stored and used at a different time when it is needed. It may be the case that the working fluid may be transformed to a liquid during the process. The liquid obtained may be stored and called for at a different time when it is needed.

In some embodiments, high temperature thermal unit 14 may contain the means to generate and store thermal energy that is relatively higher than the thermal energy temperatures generated and stored in the high temperature section of the first unit (i.e. the cold-hot unit 12).

In some embodiments, both units (i.e. cold-hot unit 12 and the high temperature thermal energy storage unit 14) may contain or be otherwise associated with means to convert electrical energy to thermal energy that may be stored. The cold-hot unit 12 may generate a liquid that may be stored at cryogenic temperatures. The process of generating and storing thermal energy and/or liquid air may be referred to as charging or charging period. The high temperature thermal energy storage unit 14 may be charged by converting electrical energy to thermal energy as stated, and may further be charged by converting heat that may be obtained by combusting a fossil fuel. Alternately, heat may be obtained by converting heat that is generated by a nuclear reactor or any other heat generating apparatus. Charging the high temperature thermal energy storage unit 14 may be done by converting electrical to thermal energy, and may also be charged by storing heat generated from an external heat source such as combustion of a fossil fuel or other source of heat (e.g. electrical heating coil), or both (i.e. electrical conversion and storing input heat). In some embodiments, it may be the case that an apparatus is constructed and arranged adjacent to a thermal energy generator, or as a standalone apparatus. In one embodiment of the disclosed matter, an apparatus is disclosed that may produce liquid air that may be in cryogenic forms and/or temperatures, that may be stored at one stage of operation and deployed in a different stage of operation. Further, high temperature thermal energy that may be stored at one stage of operation and deployed in a different stage of operation, or may be done simultaneously. Both the generation of liquid air and the high thermal energy temperatures may be generated, stored and deployed within the same apparatus.

In one embodiment, both the cold-hot unit 12 and the high temperature thermal energy unit 14 may be interconnected, allowing a working fluid to flow between both units. When the system 1 is in discharge mode, it may pump liquid air from the cold section of the cold-hot unit 12 to the hot section of the cold-hot unit 12, and from there it may pass through the high temperature thermal energy storage unit 14. This may result in an increase to the temperature delta in the working fluid, which may result in an increased electrical energy efficiency and capacity, of the system 1. It may be the case that the increase in the temperature delta of the working fluid temperature will not result in a linear increase in the efficiency of the system. The relationship between the increasing delta in the working fluids' temperature and the efficiency of the apparatus may have a bell curve, a maximum point, a local maximum etc. The thermal energy of the high temperature storage 14 that is utilized throughout the discharge process may be controlled and/or may be altered in accordance to the energy efficiency curve setting on the maximum cycle efficiency point or may want to settle on local maximum etc. In some embodiments, higher temperatures can produce higher capacity factors but can also produce lower efficiency factors. The various optimization points may be dependent on temperature levels and the selected configuration of the final stage turbine/generator stage (e.g., turbine system 16). The tuning of the final output capacity and cycle efficiency may be dependent on the storage capabilities of the high temperature thermal energy storage unit 14. The high temperature thermal energy storage 14 can be an intermediate thermal energy reservoir and not a direct source of thermal energy. Further, in some embodiments, system 1 can alternate the amount of thermal energy that is transferred from the high temperature thermal energy storage 14 to the working fluid so that electrical energy generation can alternate in such a way that as the thermal energy increases, the electrical energy generated may also increase. This may result in a higher capacity of generated electrical energy that may or may not be more efficient in terms of overall efficiency of the system 1. However, it may enable flexibility of electrical generation and/or increase the average price for electrical energy that may be sold. Further, the thermal energy that is obtained from the high temperature thermal energy storage 14 may increase the capacity and tune the efficiency of the electrical energy generation during the discharge mode. In some embodiments, the availability of the thermal energy stored in the high temperature thermal energy storage 14 can serve as a superheater, and may enable the discharge of thermal energy into the discharging air stream when needed. In some embodiments, system 1 is configured with parallel charge and discharge paths so that both functions satisfying the needs of multiple power lines may be performed in parallel. Further, both the cold-hot unit 12 and the high temperature thermal energy storage 14 may be charged for example, at periods of high electrical capacity available on the grid (e.g., periods of low demand).

FIG. 1B illustrates a storage system 1100 comprising a Liquid Air Energy Storage (LAES) facility 1102, which may operate in conjunction with an electrical storage unit (or “battery”) 1104. The storage system 1100 may be charged during one period of time and may be discharged during a second period of time. During the charging period it may be the case that the LAES facility 1102 may convert electrical energy to thermal energy, and store the thermal energy for later use. During the discharge cycle the LAES 1102 may convert the thermal energy stored in the LAES 1102 to electrical energy.

Thermal energy stored in the LAES 1102 may have a range of temperatures. It may be the case that the LAES 1102 may convert electrical energy to thermal energy at a range of high temperatures and at a range of low temperatures. Different ranges of temperatures may be stored in suitable substances for a short or prolonged period of time as is known to one who is skilled in the art. According to some embodiments, when the LAES 1102 is operating in charging mode, the LAES 1102 generates liquid air and stores the liquid air that has been generated. Generating liquid air may be achieved by assembling devices, apparatuses, flow directions etc. that working together may generate liquid air. Some devices may be rotating equipment 1106 such as compressors and/or motors. Rotating equipment 1106 can be any device, apparatus, component, or system that can generate liquid air. In some embodiments, during periods of time that LAES 1102 is operating in the charging cycle, the LAES may draw down electrical energy (from any electrical energy source) and power at least one motor and/or a compressor. The compressor may trap and compress air from the environment into the LAES 1102. As the air is compressed, its pressure and temperature may rise. The high temperature in the air may be extracted from the air and stored in a thermal energy storage unit 1112 (which can include, for example, a cold-hot unit similar to cold-hot unit 14 of FIG. 1, and the high temperature extracted from the air may be stores within the hot thermal energy storage unit of the cold-hot unit). Compressing the air and extracting the high temperature thermal energy from the air may be done once or multiple times. The heated, compressed air stream may be further processed by compression, and heat extraction processes in order to achieve liquefaction. Further processing of the air may involve reducing the air streams temperature by directing the air stream through one or more heat exchangers 1114 and/or cold storage units 1116, such that the air stream can exchange thermal energy by direct or non-direct thermal energy exchange (heat exchangers). In some embodiments, reducing the temperature of the air stream by directing the air stream through a cold storage 1116 can be achieved via the utilization of the cold capacity within the cold storage 1116, which may have been stored during the discharging cycle, as will be detailed below. The air stream may undergo further processing which may include purification of the air stream from undesired contaminants. Expansion of the air stream may be achieved by directing the air stream through an expander device 1118 or any other means or apparatuses that may reduce the pressure and temperature of the air stream. In some embodiments, the air stream at the outlet of the expander device 1118 may be liquefied. According to further embodiments, a first portion of the air stream may be liquefied and a second portion of the air stream may remain in a gaseous form. In such embodiments, the air stream, which remained in a gas form, may be separated from the liquid air in a separation device 1120. The air, which remained in a gas form, may be directed through one or more heat exchangers 1122 (which may be the same or different than heat exchangers 1114), exchanging thermal energy with the incoming air stream compressed through the LAES 1102 thus reducing the air streams temperature, prior to exiting the LAES 1102. Air stream that has transformed to liquid may be stored in a liquid air storage unit 1124. At the end of the charging process it may be the case that the LAES 1102 may contain liquid air in a liquid air storage unit 1124, and high temperature thermal energy may be stored in high temperature thermal energy storage units (not shown) of the thermal energy storage unit 1112.

According to one embodiment, at a second period, the LAES 1102 may operate in discharge mode. In such a mode of operation liquid air may be pumped throughout the LAES apparatus wherein a liquid pump 1126 may pump liquid air from the liquid air storage 1124, through thermal energy storages 1112 of the LAES 1102. During the discharge cycle, the air stream may be directed through the cold storage unit 1116. The air stream may exchange thermal energy with a suitable material located within the cold storage 1116. The relatively cold temperature of the cryogenic working fluid may be exchanged for relatively high temperature that is located within the cold storage unit 1116 after the charging cycle. The cold temperature that has been extracted from the air may be stored within the cold storage 1116 to be utilized during the charging cycle as has been described above.

According to one embodiment, the air stream exiting the cold storage 1116 may be directed to the hot thermal energy storage unit of the cold-hot unit (not shown). The thermal energy may be exchanged from the air stream and the suitable materials located within the hot thermal energy storage unit of the cold-hot unit. The heated air stream flowing from the hot thermal energy storage unit of cold-hot unit may be directed to drive a turbine 1128 which may drive a generator (not shown) thereby generating electrical energy. According to an embodiment, the system may include a high temperature thermal storage unit (not shown) similar to high temperature thermal energy storage 14 of FIG. 1. In such a scenario, the air stream flowing from the hot thermal energy storage unit of the cold-hot unit may be directed to the high temperature thermal storage unit prior to entering the turbine 1128.

It may be the case that increasing the energy capacity of the LAES 1102 may require an increase in at least some of the storage devices such as the thermal storage units 1112, and the liquid air storage units 1124. It may be the case that increasing the size of these devices may not increase the overall price of the LAES 1102 linearly. For example, by increasing the capacity of the LAES 1102 by a factor of two, the overall cost of LAES 1102 may increase by a small fraction.

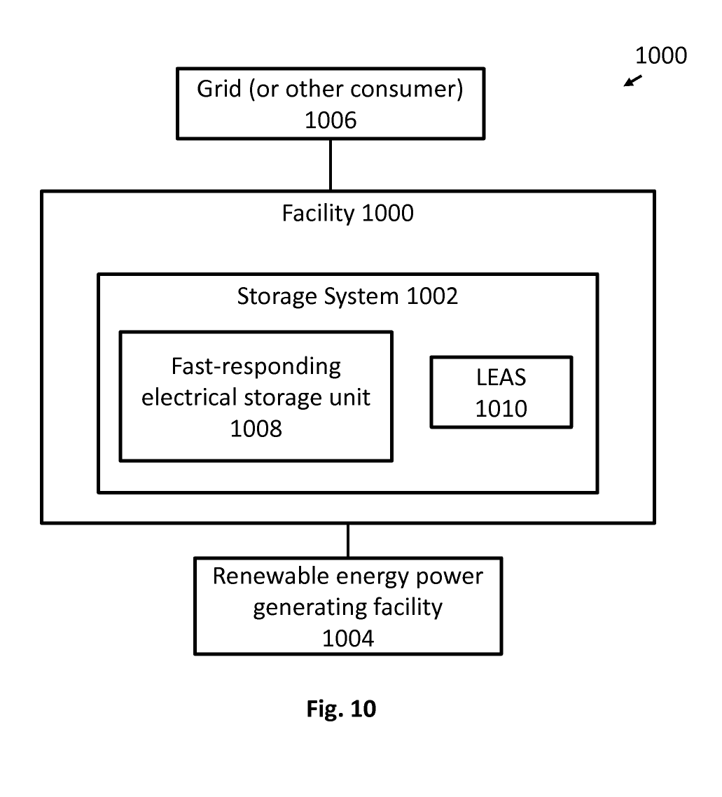

One embodiment of the disclosed matter relates to an apparatus, such as, for example, facility 1000 of FIG. 10 described below, containing LAES 1102 that operates in conjunction with electrical storage unit (or battery) 1104. The apparatus may respond in a matter of seconds or fractions of seconds, and may operate for a long period of time dispatching high power capacity. The apparatus may dispatch electrical energy to the electrical grid (or any other electrical customer) and may be dispatched to draw down electrical energy from the grid (or any other electrical energy source).

During the discharging cycle (i.e. when the said apparatus is configured to dispatch electrical energy to the electrical grid or other electrical customer) the apparatus may respond in a matter of seconds (or fractions of a second) by dispatching electrical energy from the battery 1104. The rotating equipment 1106 associated to the LAES 1102 may cycle up to operate at full capacity. Once LAES 1102 is operating and dispatching at full capacity the batteries 1104 may stop dispatching electrical energy. It may be the case that the electrical capacity generated from LAES 1102 may ramp up in a proportionally or semi proportional (i.e. capacity %/minutes). In such a case it may be that during a rapid ramp up situation the battery 1104 will be dispatched to meet the full system megawatt power capacity within the minimum time required (e.g. as low as one second). At the same time the rotary equipment 1106 in the LAES 1102 may be activated, starting with the turning on the liquid air pump 1126 and moving through the discharge cycle as described above. The electric battery 1104 may initially provide all of the delivery power from the system as the LAES rotary equipment 1106 starts ramping up to greater capacity delivery. As the LAES 1102 is ramping up, the battery 1104 capacity contribution is diminished keeping the overall output capacity constant. When the rotary equipment 1106 of the LAES 1102 reaches full capacity the battery 1104 may be deactivated, and stands ready to be recharged when the LAES 1104 is required to reduce capacity.

It should be noted that the battery 1104 in the case described above is used to assist the overall system to be able to assist the rotary equipment 1106 of the LAES 1102 meet its very stringent ramp up and ramp down specifications. The battery 1104 in these cases can be used to close minor gaps at possibly lower cost than could be obtained by tightening the specification on all of the rotating equipment 1106, heat exchangers 1114, 1122, etc.

In some embodiments, when the apparatus is instructed to stop dispatching electrical energy to the electrical grid (discharging cycle), such embodiments are configured to do so in a matter of seconds or even in fractions of a second. It may be the case that the rotating equipment 1106 associated to the LAES may ramp down; however it may be the case that during the ramp down period a portion of the capacity of the LAES 1102 will continue to generate electricity. This portion will grow smaller as the apparatus ramps down. In such a case the undesired output electrical energy may be directed to charge the battery 1104 and stop dispatching to the electrical grid.

During the charging cycle, the apparatus may respond in a matter of seconds (or fractions of a second) by drawing down electrical energy from the electrical grid to the battery 1104. The rotating equipment 1106 associated with the LAES 1102 may cycle up to operate at full capacity. Once LAES 1102 is operating and drawing down electrical energy at full capacity the batteries 1104 may stop drawing down electrical energy from the electrical grid. According to some embodiments, the apparatus may have multiple batteries 1104 to even out the capacity being drawn down from the electrical grid.

According to some embodiments, when the apparatus is instructed to stop drawing down electrical energy from the electrical grid (discharging cycle) it may be do so in a matter of seconds or fractions of a second. It may be the case that the rotating equipment associated to the LAES 1102 may ramp down, however it may be the case that during the ramp down period a portion of the capacity drawn down from the electrical grid or other source is needed to cycle down the rotating equipment 1106 associated to the LAES 1102 such as the motor and/or compressor. In such a case the LAES 1102 may draw down the needed electrical energy from the battery 1104 and stop drawing down electrical energy from the electrical grid.

According to one embodiment of the disclosed subject matter, the capacity of the electrical storage unit 1104 may be a function of the ramping time of the LAES 1102 conducted to the battery 1104. For example if the ramp rate of a 50 MW LAES system 1102 is 50% per minute, the battery 1104 capacity may be sized to 50 MW for 2 minutes. If the LAES ramp rate is different from the above example the battery 1104 capacity may be calculated accordingly. In some embodiments, the battery 1104 capacity is sized differently, for example two times the ramp time of LAES 1102, which will add flexibility to the apparatus in decision making whether or not to ramp up LAES 1102. This may be of importance if apparatus is providing fast responding frequency regulation. It may be the case that the size of the battery 1104 will be smaller. The exact size of the battery 1104 is application specific and may be calculated by the specific application and the ramp rate of the LAES 1102.

It may be the case that the cost of the battery 1104 will be a fraction of the price in relation to a battery 1104 providing the capacity of the apparatus detailed above, due to the need for a battery sized to fit the target application in relation to the ramp rate of the LAES 1102. If for example a LAES 1102 is commissioned for an application that requires that the LAES 1102 to operate at full capacity in 1 minute. For means of example the LAES's 1102 ramp rate to full capacity may be two minutes. Assuming the same capacity as the LAES 1102, a battery 1104 of 1 minute capacity may be added to the system. It may be the case that concerns will arise in regards to the ramp rate of LAES 1102. In such a case the battery 1104 will be sized to 5 minutes capacity of LAES 1102, resulting in a guarantee of 300% under performance of the ramp rate of the LAES 1102. It may be the case that providing the said battery 1104 may alleviate concerns for LAES's 1102 operation. Further, it may be the case that if the LAES 1102 performs as expected (i.e. at full capacity within 2 minutes) the excess energy stored in the batteries 1104 may be diverted to any other facility containing rotating equipment in order to reduce the ramp rate of that facility.

The system described in FIG. 1 can also operate in fast responding operations. It may be the case that the controller 6 may control and configure system 1 in such a way to allow for the system to operate in fast responding operations. In such a case during the discharge cycle it may be that the controller 6 may send commands to the electrical storage unit 8 to dispatch electrical energy to the electrical grid. The controller 6 may order converter 9 to dispatch electrical energy by converting thermal energy stored in one or both thermal storages 14, 12 and drive devices such as expanders located in turbine system 16. It may be the case that electrical storage 8 may dispatch electrical energy to the electrical grid during the cycling up time of the rotating equipment. It may be the case that once the rotating equipment is operating at full load the controller 6 may send commands to the electrical storage 8 to stop dispatching electricity. It may be the case that electrical storage 8 may contain one or more electrical storage devices (batteries) that may be controlled in order to dispatch an even electrical capacity to the grid. It may be the case that at the end of the discharge cycle, electrical energy from the output of turbine 16 may be directed to charge electrical storage 8 thus resulting in an immediate stop of electrical output from system 1 to the electrical grid.

According to some embodiments, controller 6 may control and configure system 1 in such a way as to allow for the apparatus to operate in a fast responding operations. In such a case during the charge cycle it may be that controller 6 may send commands to the electrical storage unit 8 to draw down electrical energy from the electrical grid. The controller 6 may send commands to converter 9 to operate, resulting in a drawdown of electrical energy from the electrical grid. It may be the case that converter 9 may have a ramping time associated with its operation. It may be the case that the controller 6 may send commands to the electrical storage unit 8 to stop drawing down electrical energy once converter 9 is operating at full capacity. It may be the case that during the cycling down of the charging mode, rotating equipment associated with converter 9 may still draw down electrical energy. The energy needed during the cycling down of the rotating equipment may be drawn down from the electrical storage unit 8.

The system may couple together all the needed components as mentioned above in order to enable various energy generation and demand systems to interact, depend and complement one another etc. It achieves this in such a way that allows comprehensive energy and electricity management. The processing system enables a power facility to meet its energy needs in an efficient way, while ensuring energy production that is reliable, dependable and smooth. The system may add desirable features such as flexibility to fossil fuels plants, or base load power plants), and may increase the reliability of the renewable energy sources and may enable valuable time delivery of renewable energy thus allowing more clean energy to enter the power network at cost effective prices while simultaneously helping to protect the environment.

FIG. 3 illustrates commands being passed from the front end system input 20 to the control system 100. The commands that the control system 100 receives may address a number of energy issues, including frequent energy issues such as, for example, target capacity on grid 101, excess capacity on grid 102, intermittent capacity on grid 103, capacity demand on grid 104, and commanded capacity on grid 105.

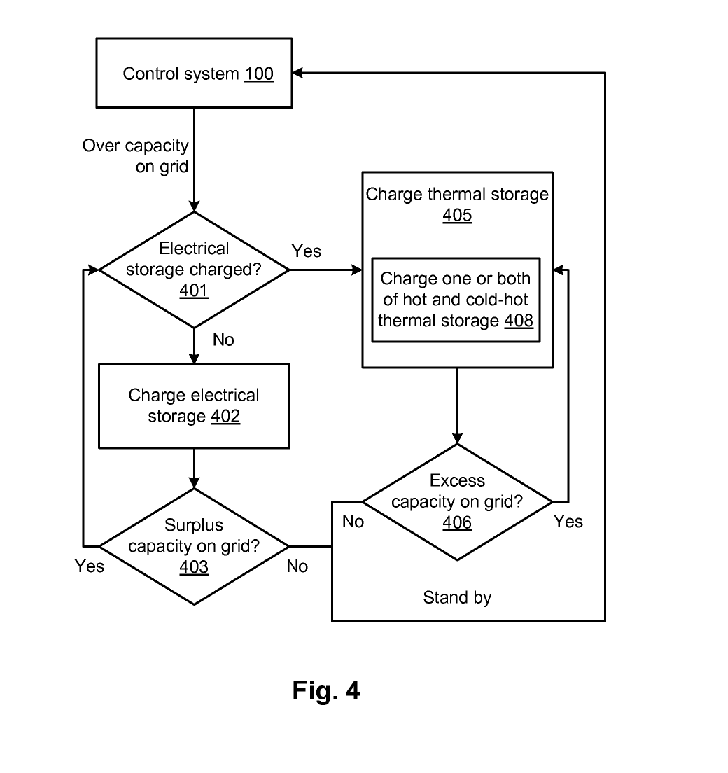

In operation, data can be received, observed, and/or detected via front end system input 20. Front end system input 20 can generate control data 31, detector data 32, and/or other data/commands (not shown) and transmit the data/commands (e.g., 31 and 32) to control system 100. Control system 100 can be configured to determine an occurrence of one or more of issues 101-105 based on the data received from front end system input 20 and perform operations based on the determined occurrence(s) as described in FIGS. 4-8 below.

FIG. 4 illustrates how the issue of over-capacity on the grid may be solved. One who is skilled in the art will understand that at many times the issue of over-capacity may occur as a result of unusual weather conditions such as but not limited to windy nights (e.g., wind turbines), or sunny days (e.g., solar energy). When a grid suffers from over-capacity, it may be the case that a portion of the energy may be curtailed, and it may be the case that the curtailed energy may originate from a renewable energy source. There may be other methods to reduce electrical energy capacity from the grid such as for example, forced demand, cycling down base load to a lower load etc.

FIG. 4 illustrates that the control system 100 has received and/or detected signal of over capacity on the grid 102. The control system may then determine whether the electrical storage is charged 401. If the answer is no, the system may consume energy capacity from the grid and charge the electrical storage 402, resulting in reducing the electrical energy on the grid but storing it in order to use it when needed. As the electrical storage is charging, the system may constantly or repeatedly determine whether there is over capacity on the grid 403. If the answer is yes, the system will continue to determine whether the electrical storage is charged 401, and if the answer is no at 401, then it may act as detailed above. This may happen up until the system receives a positive answer to 401. In some embodiments, this may also happen if any other consideration such as, for example, the ramping rate consideration occurs. When it is determined at 401 that the electrical storage is charged, the system will then charge the thermal storage 405. Depending on the system configuration or the immediate requirements the system may charge a thermal storage, for example, it may charge one or both of the hot and cold-hot thermal storage as indicated at 405. Charging of the cold-hot storage unit 408 may include the generation of liquid air. The system may continue to calculate excess capacity on the grid 406. If there is excess capacity, the thermal storage units is/are directly charged. If the answer is negative, the system will stand-by and wait for orders from the control system.

The stated process described hereinabove shows how the system is able to solve the issue of over-capacity on the grid, in such a way that enables energy that may otherwise be wasted, curtailed, forced to be consumed, or require base load power plants to operate at reduced loads (which may result in an efficiency loss).

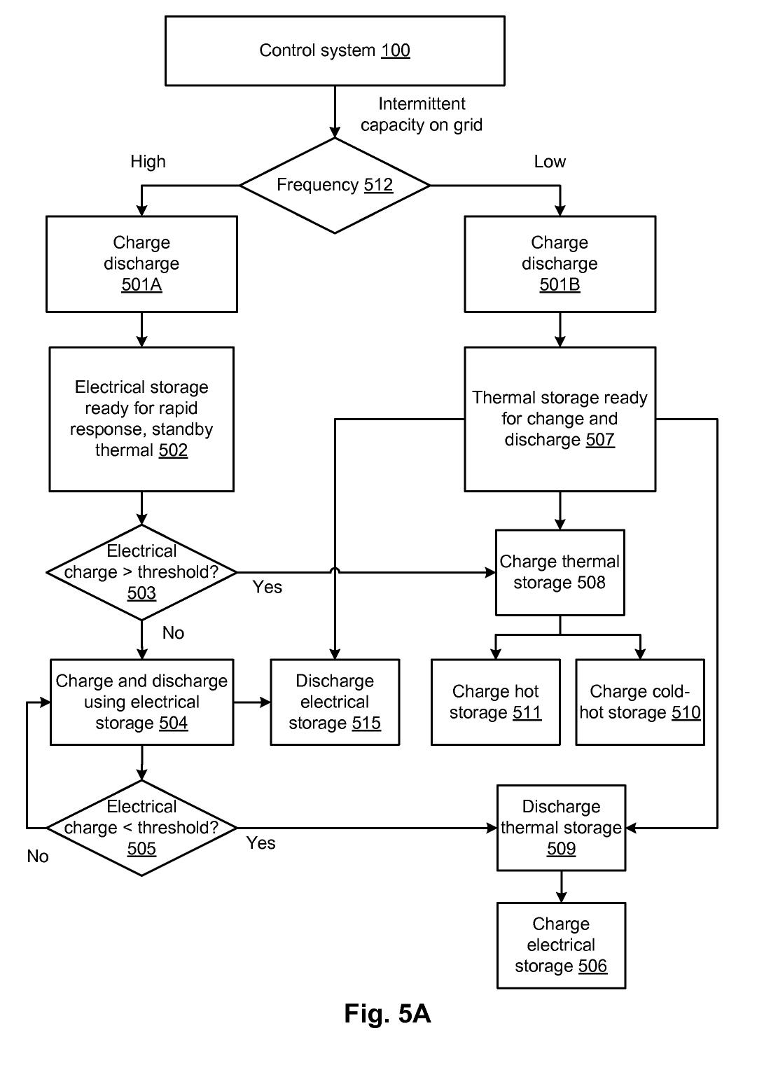

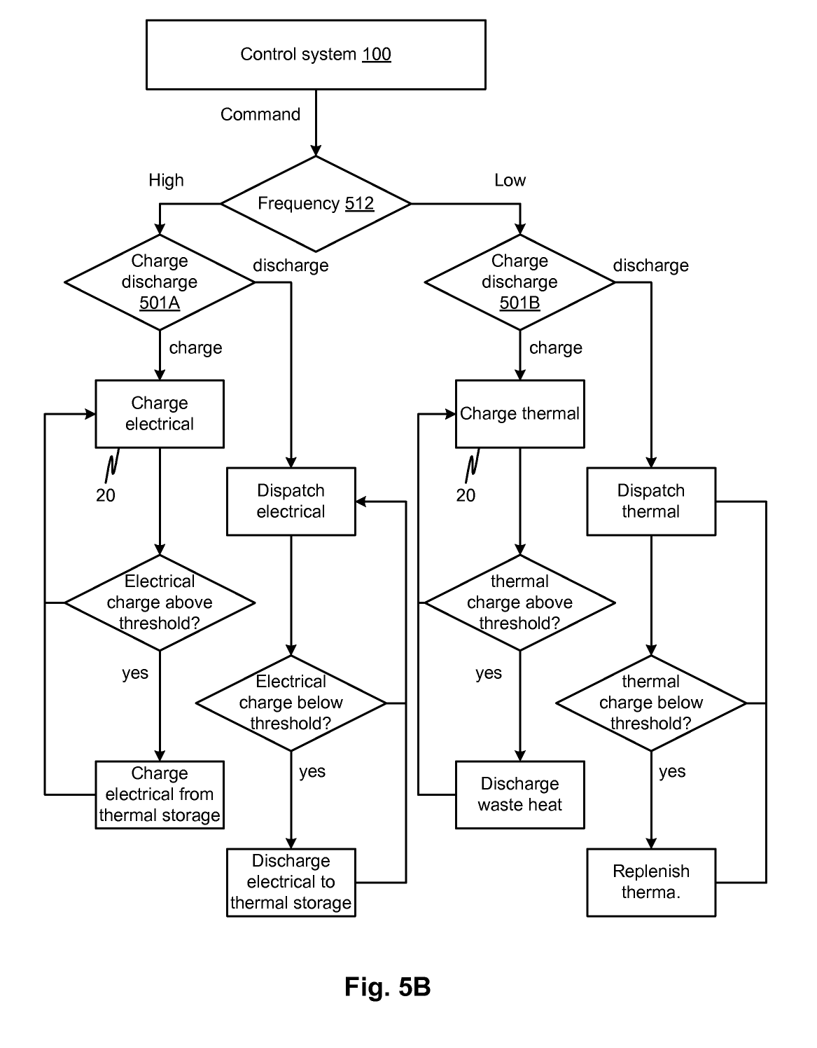

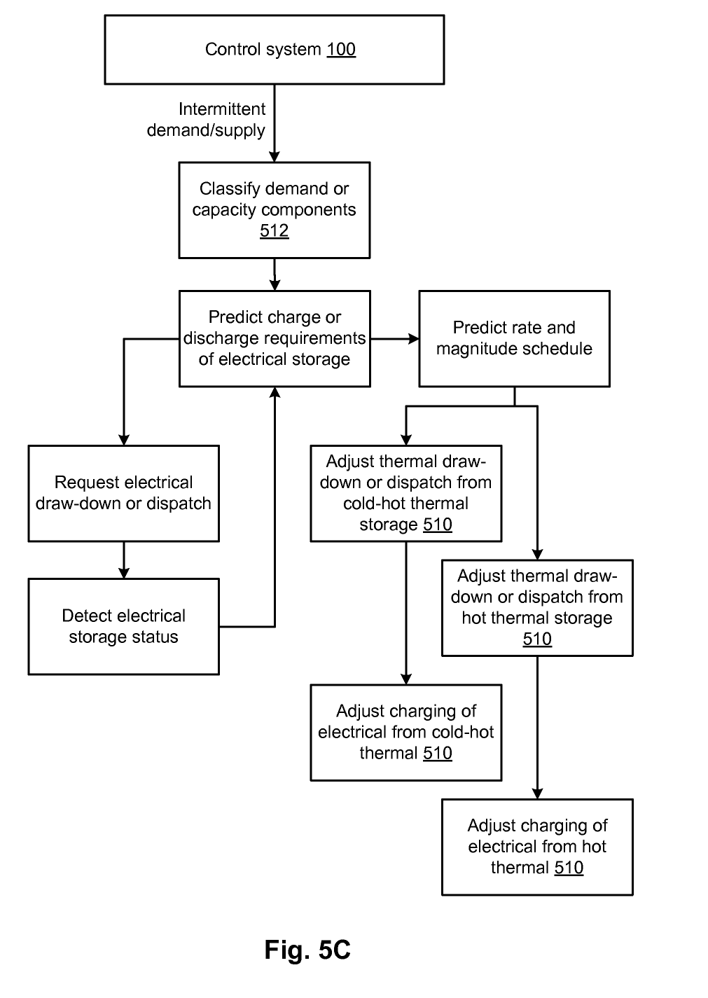

FIG. 5 illustrates how the issue of intermittent energy may be solved by the present disclosure. One who is skilled in the art will understand that many times the issue of intermittency is typically a result of renewable energy.

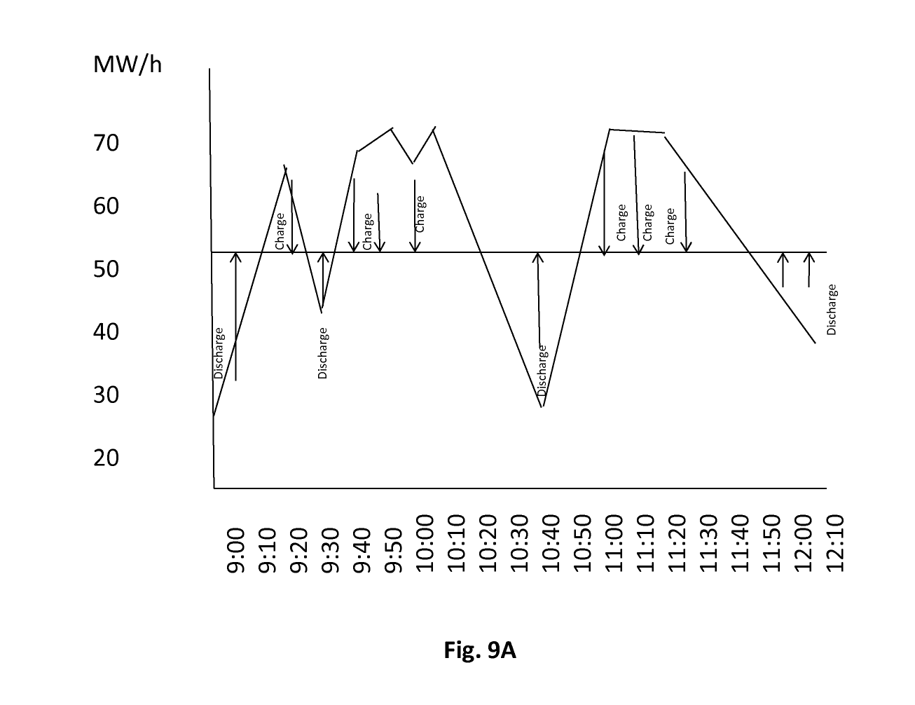

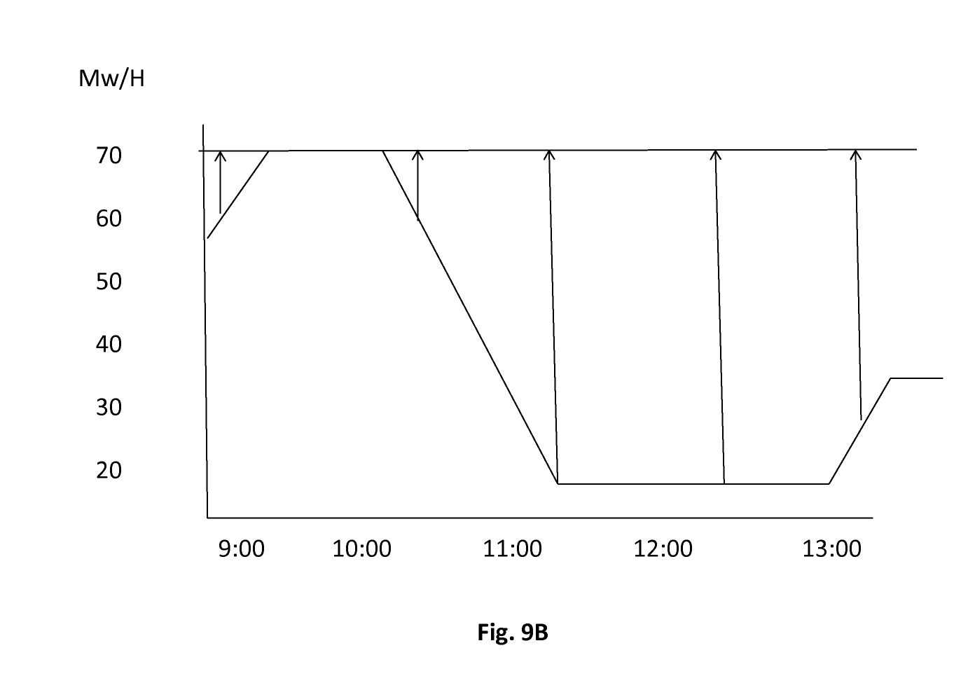

Intermittent energy can have high or low frequency. High frequency energy (as shown in FIG. 9A) can occur when the energy capacity moves in rapid movement from high to low (or low to high), wherein the period of time from high to low may be relatively short such as a matter of seconds or minutes. Low frequency energy (as shown in FIG. 9B) is when the shift from peak to trough may occur in a longer period of time such as a matter of hours or days etc.

Intermittent energy flow may not be a desired energy flow, and there may be a need for a facility that can smoothen out the energy capacity. Smoothing out energy capacity can be to the peak (as illustrated in FIG. 9B) of the intermittent energy capacity or to average out (as illustrated in FIG. 9A) the energy capacity to a predefined average between high and low.

FIG. 5A illustrates a scenario when control system 100 receives data/commands indicating intermittent capacity on grid 103 and configures the system in order to solve problems of intermittent energy. The intermittent energy may be high or low frequency energy 512. The system can be configured to solve high frequency intermittency 513 by charging and discharging the electrical storage 501, 502. The electrical storage unit can respond rapidly, thus enabling the facility to smooth out the intermittent energy to peak or to average. When the electrical storage is called for rapid response the system may call the thermal energy storage (i.e. the LAES or more specifically the energy stored with in the LAES or energy to be stored with in the LAES) to be prepared in standby mode 502. The system may determine whether the electrical storage is at full charge 503. If the answer is positive then the system may charge the thermal energy storage (i.e. the LAES) 508 at high points of intermittency, and discharge the electrical storage at low points 515 (and can then enter stand-by). If the answer to whether the electric storage is fully charged 503 is negative then the system may choose to charge and discharge the electrical storage 504. The system may then determine whether the electrical storage is empty 505. If the answer is positive the system may generate energy by discharging energy from the thermal energy storage (i.e. the LAES) 509, and/or may choose to charge the electrical storage unit 506. If the answer is negative at 505 then the system may choose to charge and discharge the electrical storage 504.

The system may determine at any point if there is intermittency on the grid and if the answer is positive the system may continue to operate as it is, and if the answer is negative the system may stand by and wait for orders.

The system may detect low frequency on the grid 514. The system may detect if there is a need to charge or discharge the system 501. If the answer is yes, the system may choose at 507 to charge 508 or discharge 509 the thermal energy unit (i.e. the LAES), and/or may choose to discharge energy from the electrical unit 515. When charging the thermal energy unit (i.e. the LAES), the system may may charge the cold-hot storage unit (and generate liquid air) 510, the high temperature storage unit 511, or both. The system may discharge the thermal energy unit 509. At 509, the system may discharge the cold hot units, or may discharge the cold hot units coupled with the hot unit. At any time the system may determine whether there is intermittent energy on the grid, and when the answer is positive the system may operate as it is, and when the answer is negative the system may stand-by and wait for orders from the control system. At the end of a discharge cycle 509 the system may recharge its electrical storage 506 from energy that is produced from discharging its thermal energy storage (i.e. the LAES).

According to some embodiments of the disclosure the system may react very rapidly even in a fraction of a second, and can operate in high (as shown in FIG. 9A) and low (as shown in FIG. 9B) frequencies of intermittency. It can smooth the intermittent energy to peak (as shown in FIG. 9B) or an average (as shown in FIG. 9A). It can operate as backup for both short and prolonged periods. It may not suffer from a loss of efficiency, or have limited loss in efficacy when turned on and off or cycled up and down, and may not produce an increase in unnecessary, unwanted NOx.

FIG. 5B is a flow diagram illustrating a method of controlling the system to achieve a desirable mode of operation during a state of intermittent demand/supply of energy on the grid, according to one or more embodiments of the disclosed subject matter. The method begins at 512 where the control system 100 determines whether the intermittent energy is high or low frequency energy. If the intermittent energy is determined to be high energy, the method proceeds to 501A and if it is determined to be low energy the method proceeds to 501B.

At 501A, the method includes determining whether to begin an electrical charge and/or discharge cycle. The control system 100 can be configured to solve high frequency intermittency by charging and discharging the electrical storage because electrical storage (e.g., electrical storage unit 8 shown in FIG. 1A, electrical storage unit 1104 shown in FIG. 1B, and fast-responding electrical storage unit 1008 shown in FIG. 10) can respond rapidly, thus enabling the facility to smooth out the intermittent energy to peak or to average. If control system 100 determines, at 501A, to charge the electrical storage, for example, during periods of excess capacity in the grid, the method proceeds to charge the electrical storage and when the electrical storage is charged above a predetermined threshold (e.g., when the electrical storage is completely charged, or close to fully charge), the method proceeds to charge the thermal storage with the excess electrical capacity from the grid. The control system can determine, at 501A, to discharge the electrical storage to provide electrical energy to the grid quickly, for example, when the demand exceeds or is close to exceeding the capacity of the grid.

At 501B, the method includes determining whether to begin a thermal charge and/or discharge cycle. The control system 100 can be configured to solve low frequency intermittency by charging and discharging the thermal storage because thermal storage (e.g., 12 and 14 of FIGS. 1A, 1112 and 1116 FIGS. 1B, and 1010 of FIG. 10) can efficiently respond to low frequency intermittent energy. If control system 100 determines, at 501B, to charge the thermal storage, for example, during periods of excess capacity in the grid, the method proceeds to charge the thermal storage and when the thermal storage is charged above a predetermined threshold (e.g., when the thermal storage is completely charged, or close to fully charged), the method proceeds to charge the electrical storage with the excess electrical capacity from the grid. The control system can determine, at 501B, to discharge the thermal storage to provide electrical energy to the grid, for example, when the demand exceeds or is close to exceeding the capacity of the grid.

FIG. 5C is a flow diagram illustrating a method of delivering electricity from an electrical production and storage site to a grid where there exists intermittent demand/supply of energy on the grid, according to one or more embodiments of the disclosed subject matter.

The method begins with control system 100 receiving data representing demand and/or capacity of the grid. The control system can be a processor-based programmable control system with memory and connected to sensors adapted for receiving signals indicating a current net demand or excess capacity of the grid and further to detect a rate of change of said net demand or excess capacity and generate command signals responsively to said detecting. The control system can be configured to store data representing a time rate of change of said net demand or excess capacity.

The method can include predicting, by the control system, charge or discharge requirements of the electrical storage component, where the electrical storage component is configured to store power from a grid and deliver power to the grid at first load and capacity tracking rates. Based on the prediction, the control system generates a signal to request drawn-down or dispatch of the electrical storage component. The method can include detecting, by the control system, a status of the electrical storage component, and based on the status, the method can include recalculating the predicted charge or discharge requirements of the electrical storage component based on the detected status.

The method can also include predicting, by the control system, responsively to both the stored data representing a time rate of change of the net demand or excess capacity and additional data that represents a model of the grid, a future schedule of electrical power demand and supply of the grid. The method can include controlling, based on the predicted future schedule, a thermal storage component configured to store power from a grid and deliver power to the grid at second load and capacity tracking rates that are slower than the first load and capacity tracking rates of the electrical storage component.

Based on the predicted schedule, the method can include adjusting, by the control system, thermal draw down or dispatch from the thermal storage component which can include cold-hot thermal storage and/or hot thermal storage. The thermal draw down or dispatch can include thermal draw down or dispatch of one or both of the cold-hot thermal storage and hot thermal storage.

The method can also include controlling, responsively to the stored data representing the time rate of change of the net demand or excess capacity, a rate of storage or delivery to or from the electrical storage component and to or from the thermal storage component where the rate and quantity of electrical power to store or deliver from the electrical storage component and the thermal storage component are independent of each other.

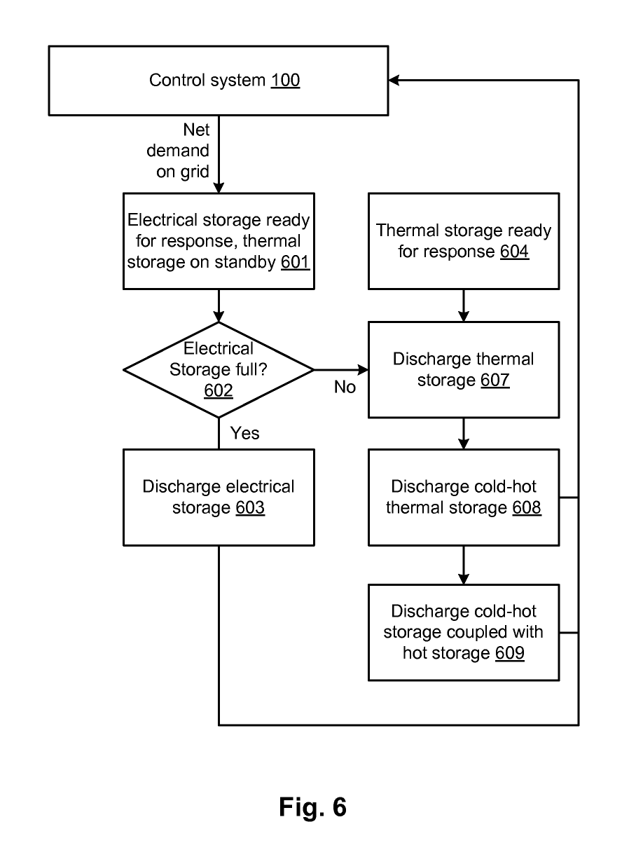

FIG. 6 illustrates a scenario in which the control system 100 receives data/commands indicating that there is capacity demand on the grid 104. One who is skilled in the art will understand that this need results from higher demand of energy that may be due to peak hours, added demand requirements, days without sun, nights without wind etc. The control system 100 may configure the system to produce energy. The control system 100 may call the electrical storage to be ready to respond 601 and may call the thermal energy unit (i.e. the LAES) to be on standby 601. The control system 100 may determine whether the electrical storage is full 602 and, if the answer is positive, the control system 100 may discharge the electrical storage 603. If the answer is negative, the control system 100 may discharge the thermal energy storage (i.e. the LAES) 607 to produce energy. If the system is discharging the electrical storage it may determine periodically or at irregular/random intervals if the electrical storage is full 602, and act according to the above.

The control system 100 may choose to discharge the thermal energy unit (i.e. the LAES) and not use the electrical storage unit by calling the thermal storage unit (i.e. the LAES) to be ready for response 604. The control system 100 may discharge the thermal energy storage units (i.e. the LAES) 607. The system may discharge the cold-hot units 608, or may discharge the cold-hot units coupled with the hot unit 609. At any point of time the system may determine whether there is a need for more energy on grid and if the answer is positive, the control system 100 may continue to operate as before, and if the answer is negative, the control system 100 may stand by and wait for orders from the control system.

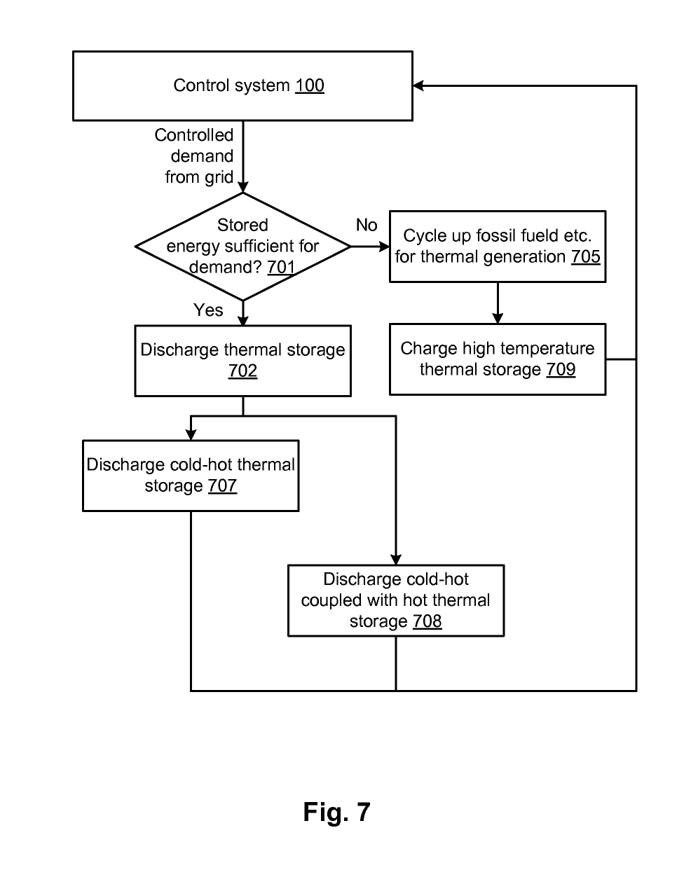

FIG. 7 illustrates a scenario when control system 100 receives data/commands to configure the system to deploy energy that was schedule in advanced 105. The control system 100 may calculate if there is enough stored energy in the system to meet the need 701. In some embodiments, if the answer is positive the control system 100 may discharge the electrical storage unit. The control system 100 may determine whether the electrical storage unit is empty, and if the answer is positive the control system 100 may discharge the thermal energy unit (i.e. the LAES) 702. The control system 100 may discharge the thermal storage cold-hot unit 707, and/or the system may discharge the thermal storage cold-hot unit coupled with the hot unit 708. If the answer at 701 is negative, the control system 100 may then cycle up thermal energy generation 705 (e.g. combustion of fossil fuel etc.). This can generate thermal energy that may be used to increase high temperature thermal energy located in the thermal storage of the hot unit 709. At predetermined intervals, irregular/intermittent intervals, and/or any moment the control system 100 may determine whether there is need for more energy on the grid, if the answer is positive the system may continue operating as before, and if the answer is negative the system may stand by and wait for orders from the control system 100.

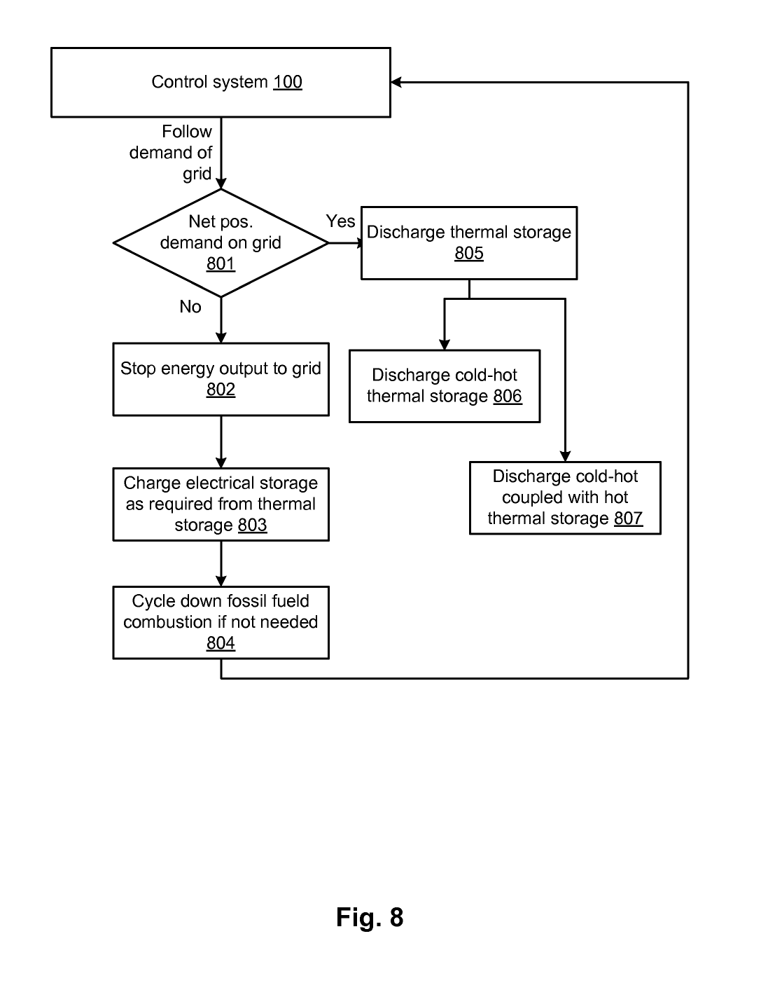

FIG. 8 illustrates a scenario when control system 100 receives data/commands to configure the system to act according to a target capacity on the grid 101. The control system 100 may determine whether the capacity that is on the grid 801 is being met (i.e., the control system 100 can determine whether the generation of energy capacity is contributing to the state of equilibrium of supply and demand of energy on the grid). If the answer is negative, the control system 100 may stop energy output or draw down 802. The control system 100 may charge the electrical storage if needed from thermal energy unit (i.e. the LAES) 803. It may be the case that the system may have a fuel combustion source, and the control system 100 may cycle down combustion of fossil fuel if not needed 804. The control system 100 may then stand by and wait for orders from the control system

If the control system 100 determines, at 801, that the system is needed to meet the target capacity on the grid, the control system 100 may discharge the thermal energy unit 805. The control system 100 may discharge the thermal storage cold-hot unit 806, and/or the control system 100 may discharge the thermal storage cold-hot unit coupled with the hot unit 807 in order to meet the target capacity.

According to one or more embodiments of the disclosed subject matter, the system can be turned on and off without significant efficiency loss.

Further the combination of the capabilities may provide specific solutions for specific industries such as the renewable energy industry.

FIG. 10 illustrates a system (or “facility”) 1000 containing a storage system (or “storage apparatus”) 1002 with multiple devices and apparatuses in conjunction with a renewable energy power generating facility (or “renewable energy apparatus”) 1004, according to one or more embodiments of the disclosed subject matter.

The facility 1000 can comprise one or more apparatuses, including storage system 1002 as detailed hereinabove, and a second apparatus may be renewable power generating facility 1004. The storage system 1002 may allow the renewable power generating facility 1004 to supply power to the grid 1006 at needed times and in needed forms (i.e. non-intermittent power), thus increasing the overall price of power sales in addition to meeting the needed power requirements of the grid. According to the embodiment, the facility 1000 may operate in a few modes of operation. In a first mode of operation, the facility 1000 may dispatch power that is generated from one of the renewable energy apparatuses 1004 to the grid 1006 (or any other consumer). A second mode of operation may result in the facility 1000 not dispatching power to the grid 1006 (or other consumer). It may be the case that during a period of time in which the renewable energy apparatus 1004 is generating power, but the grid 1006 is in a state of overcapacity or alternatively in a state of balanced power (equilibrium), adding power may cause the grid 1006 to have excess power. In this case, the facility 1000 may store the electricity generated from the renewable energy apparatus 1004 in the storage apparatus 1002. A third mode of operation may result in the facility dispatching power from both the renewable energy apparatus 1004 and from the storage system 1002 at the same time. A fourth mode of operation may result in the facility 1000 dispatching power from the storage system 1002 alone. A fifth mode of operation may result in the facility 1000 drawing down power from the grid 1006 and storing the power within the storage system 1002.

At different periods of time throughout the week there may be a higher or lower demand for power. An example of such periods may be the demand during weekends versus weekdays. It should be noted that other conditions, time periods, events etc. exist, and that this example should be considered as true for other specific conditions, time periods, events etc. During weekends the demand for power is lower than the demand during weekdays. The shift in the demand does not cause a shift in power generation of renewable energy, simply due to the fact that the sun still shines and the wind still blows during the weekends. It may be the case that in some specific regional grids there may exist no need or desire to add power during the weekends and there may even be a need or desire to draw down power that is being generated for such grids. According to the embodiment, the facility 1000 may store the generated power from the renewable energy apparatus 1004 in the storage system 1002 throughout the weekend (or a portion of the power or a portion of the weekend power). The power may be directed and stored in the storage system 1002 throughout the weekend, and may be dispatched during the weekdays. According to an embodiment, storage capacity of the facility 1000 may be sized in order to enable the storage of the power that is generated throughout the weekend. The storage capacity of the facility 1000 may be suitable for the stated purpose of storing the power of the renewable energy apparatus 1004 during the weekend, but in some embodiments the storage capacity may be larger than needed for the renewable energy apparatus 1004 during weekdays. During the weekdays the facility 1000 may provide storage capacity for the grid 1006. Further, during the weekdays (or weeknights) the grid 1006 may suffer from a state of overcapacity, in such a case the facility 1000 may draw down power from the grid 1006, and store it to be utilized (and dispatched to the grid) during a second period of time when there is a need for additional power capacity on the grid 1006.

It may be the case that renewable energy sources suffer from issues of intermittency, which may be of high and/or low frequency. According to this embodiment, the storage system 1002 may be configured to operate in such a way that may enable the facility 1000 as a whole to dispatch non-intermittent (or close to non-intermittent) power to the grid 1006. The storage system 1002 may be interconnected to the electrical output of the renewable energy apparatus 1004. Through sensors and other detection and control devices, apparatuses, systems etc. (e.g., control system 100 described above for FIGS. 2-8) the facility 1000 may operate the storage system 1006 in order to balance out, form, and/or shape etc. the power output of the facility 1000 to the grid 1006. In accordance with the capacity that is generated from the renewable energy sources, the storage system 1002 may add additional capacity (if the renewable energy sources are generating excess capacity), draw down capacity (if the renewable energy sources are generating a deficiency of needed capacity), or remain idle (if the renewable energy sources are generating the projected capacity). The storage system 1002 may respond as needed with one or more of the disclosed storage apparatuses within the storage system 1002. Whereas for a needed fast response, the storage system may initially respond with a fast-responding electrical storage unit 1008. The response may be to add or reduce power that has been generated from the renewable energy source 1004. In the event that the intermittency is of low frequency and requires a prolonged period and/or a large capacity correction from the storage system, the storage system 1002 may facilitate this need via a LAES 1010. The LAES 1010 may facilitate the needed action, whether it is to add additional needed power or to reduce the power being generated from the renewable energy source 1004.

According to some embodiments, the renewable energy source 1004 may be a Photovoltaics (PV) facility. A PV facility may suffer from both the issue of generating power when it is not needed, and from intermittency issues, as known to one who is skilled in the art. Further, a PV facility may dispatch DC electrical power. It may be the case that the operating components within the storage system 1002 may operate with DS power. Thus, in the event that the power that is being generated from the PV facility is not desired and/or the facility 1000 is operating in a mode of operation that results in not supplying power to the grid, the power that is generated from the PV facility may be converted and stored as energy in the storage system 1002, without undergoing a DC/AC conversion. As such, some of the efficiency loss that occurs during the conversion of DC power to AC power may be avoided.

According to first embodiments thereof, a method of operating an energy storage system can comprise detecting by one or more sensors electrical properties indicating current or expected electricity levels, and generating therefrom, at least one signal indicating a current or impending change in electricity levels. In first embodiments, the method can comprise receiving at least one signal from the sensors that indicate changes in electricity levels. In first embodiments, the method can comprise calculating, responsively to said receiving at least one signal, characteristics of a current change in electricity levels or of an impending change in electricity levels. In first embodiments, the method can comprise, in response to a result of the calculating characteristics, calculating a quantity of available electricity. In first embodiments, the method can comprise, in response to a result of said calculating a quantity, controlling the energy storage system. In first embodiments, the energy storage system can comprise a fast-responding electrical storage system and a large capacity thermal energy storage system.

Any of the foregoing first embodiments can be varied to form additional first embodiments in which the thermal energy storage system is a cryogenic energy storage system. Any of the foregoing first embodiments can be varied to form additional first embodiments in which the fast-responding electrical storage system is at least one selected from an electrochemical storage system, battery, supercapacitors, ultracapacitors or flywheels. Any of the foregoing first embodiments can be varied to form additional first embodiments in which the sensors include at least one of a current sensor, a voltage detector, and an electricity frequency sensor. Any of the foregoing first embodiments can be varied to form additional first embodiments in which the detecting further includes detecting at least one of (i) commands from operators; (ii) electricity pricing; and (iii) scheduled hours for needed action, and wherein the receiving further includes receiving data from the step of detecting. Any of the foregoing first embodiments can be varied to form additional first embodiments in which the change of electricity levels is one of a change in electricity frequency and a change of electricity capacity. Any of the foregoing first embodiments can be varied to form additional first embodiments in which the calculating further includes, responsively to said receiving at least one signal, characteristics of a current change in electricity demand levels or of an impending change in electricity demand levels. Any of the foregoing first embodiments can be varied to form additional first embodiments in which the characteristics of a current change or impending change in electricity levels or demand levels is one of time of day delivery, speed of response required, cost of electricity, weather. Any of the foregoing first embodiments can be varied to form additional first embodiments in which when the calculated quantity is above a predetermined threshold, excess energy is stored in the fast-responding electrical storage system and/or thermal energy is stored in the thermal energy storage system. Any of the foregoing first embodiments can be varied to form additional first embodiments in which when the calculated quantity is below an acceptable threshold, electrical energy stored in the fast-responding electrical storage system is discharged prior to, subsequent to or in conjunction with the thermal energy stored in the thermal energy storage system. Any of the foregoing first embodiments can be varied to form additional first embodiments in which when the calculated quantity is below an acceptable threshold, electrical energy stored in the fast-responding electrical storage system is discharged. Any of the foregoing first embodiments can be varied to form additional first embodiments in which when the calculated quantity is below an acceptable threshold, energy stored in the thermal energy storage system is discharged.

According to second embodiments thereof, a system for storing electricity is disclosed. In second embodiments, the system can include a fast-responding electrical storage system configured to store electrical energy. In second embodiments, the system can include a thermal energy storage system comprising a first and second thermal reservoir. In second embodiments, the system can include a control system configured to optimize energy storage. In second embodiments, the control system can be configured to maintain a balance of stored energy in the fast-responding electrical storage system and in the thermal energy storage system in response to a control signal. In second embodiments, the control signal can be generated from one or more sensors that indicate changes in electricity levels.

Any of the foregoing second embodiments can be varied to form additional second embodiments in which the thermal energy storage system is a cryogenic energy storage system. Any of the foregoing second embodiments can be varied to form additional second embodiments in which the fast-responding electrical storage system is at least one selected from an electrochemical storage system, battery, supercapacitors, ultracapacitors or flywheels. Any of the foregoing second embodiments can be varied to form additional second embodiments in which the system further comprises an electronic circuit configured to analyze data descriptive of prevailing or historic electricity usage levels, and to effect the detection in accordance to a result of the analysis. Any of the foregoing second embodiments can be varied to form additional second embodiments in which the electronic circuit includes one or more analog, digital electronics and computer executable code. Any of the foregoing second embodiments can be varied to form additional second embodiments in which the control system is configured to control the system such that: at a first operating period, excess energy is used to store energy in at least one of the fast-responding electrical storage system and the thermal energy storage system, wherein the thermal energy storage system stores hot thermal energy in the first reservoir and cryogenic fluid in the second reservoir; and at a second operating period, electrical energy stored in the fast-responding electrical storage system is discharged prior to, subsequent to, or in conjunction with the thermal energy stored in the thermal energy storage system. Any of the foregoing second embodiments can be varied to form additional second embodiments in which, during the second operating period, electrical energy stored in the fast-responding electrical storage system is discharged. Any of the foregoing second embodiments can be varied to form additional second embodiments in which, during the second operating period, energy stored in the thermal energy storage system is discharged. Any of the foregoing second embodiments can be varied to form additional second embodiments in which the system can further include a high temperature storage system, wherein the high temperature storage system is charged via an external heat source. Any of the foregoing second embodiments can be varied to form additional second embodiments in which the high temperature storage is at a higher temperature than the temperature of the storage material in the first reservoir, and the temperature of the storage material in the first reservoir is at a higher temperature than the working fluid in the second reservoir. Any of the foregoing second embodiments can be varied to form additional second embodiments in which the first reservoir and the second reservoir are thermally connected to each other so as to enable heat transfer of the storage materials. Any of the foregoing second embodiments can be varied to form additional second embodiments in which the system can further include an electricity generating system including at least one turbine and/or expander to generate electricity, the electricity generating system being coupled to the thermal energy storage so as to receive hot pressurized working fluid therefrom. Any of the foregoing second embodiments can be varied to form additional second embodiments in which, during the first operating period there is at least one of overcapacity of electricity on the grid, undesired power, or the cost of power is inexpensive. Any of the foregoing second embodiments can be varied to form additional second embodiments in which, during the second operating period there is a need of electricity on the grid.

According to third embodiments thereof, a method of operating an energy storage system is disclosed. In third embodiments, the method can comprise, at a first operating period: storing a first portion of excess energy in an fast-responding electrical storage system; and storing a second portion of excess energy in a thermal energy storage system, the thermal energy storage system storing thermal energy in a first thermal reservoir and stores a cryogenic fluid in a second reservoir. In third embodiments, the method can comprise at a second operating period: pumping the cryogenic working fluid in the second reservoir to the first reservoir so as to transfer enthalpy from the storage material to the working fluid; and using the heated working fluid generated by said flowing to drive at least one turbine and/or expander so as to produce electricity.

Any of the foregoing third embodiments can be varied to form additional third embodiments in which the thermal energy storage system is a cryogenic energy storage system. Any of the foregoing third embodiments can be varied to form additional first embodiments in which the fast-responding electrical storage system is at least one selected from an electrochemical storage system, battery, supercapacitors, ultracapacitors or flywheels. Any of the foregoing third embodiments can be varied to form additional third embodiments in which the working fluid may be directed to a high temperature storage system; wherein the working fluid may be further heated. Any of the foregoing third embodiments can be varied to form additional third embodiments in which the further heated working fluid is directed to the at least one turbine and/or expander so as to produce electricity. Any of the foregoing third embodiments can be varied to form additional third embodiments in which the further heated working fluid flowing from the high temperature storage system is at a higher temperature than the heated working fluid flowing from the first reservoir and the temperature of the heated working fluid flowing from the first reservoir is at a high temperature than the working fluid in the second reservoir.

According to fourth embodiments thereof, an electrical storage system is disclosed. In fourth embodiments, the system can include a renewable power generation system. In fourth embodiments, the system can include a fast-responding electrical storage system so as to store electrical energy. In fourth embodiments, the system can include a thermal energy storage system including a first and second thermal reservoir. In fourth embodiments, the system can include a control system configured to optimize the energy storage, the controller configured to maintain a balance of stored energy in the fast-responding electrical storage system and in the thermal energy storage system in response to a control signal. In fourth embodiments, the control signal can be generated from one or more sensors that indicate changes in electricity levels.

Any of the foregoing fourth embodiments can be varied to form additional fourth embodiments in which the renewable system may be selected from at least one of a PV plant, wind plant, any other renewable source that suffers from intermittency problems of high and/or low frequency. Any of the foregoing fourth embodiments can be varied to form additional fourth embodiments in which the thermal energy storage system is a cryogenic energy storage system. Any of the foregoing fourth embodiments can be varied to form additional fourth embodiments in which the fast-responding electrical storage system is at least one selected from an electrochemical storage system, battery, supercapacitors, ultracapacitors or flywheels. Any of the foregoing fourth embodiments can be varied to form additional fourth embodiments in which the system further comprises a high temperature storage system, and the high temperature storage system is charged via an external heat source. Any of the foregoing fourth embodiments can be varied to form additional fourth embodiments in which the system further comprises an electronic circuit configured to analyze data descriptive of prevailing or historic electricity usage levels, and to effect the detection in accordance to the results of the analysis. Any of the foregoing fourth embodiments can be varied to form additional fourth embodiments in which the electronic circuit includes one or more analog, digital electronics and computer executable code. Any of the foregoing fourth embodiments can be varied to form additional fourth embodiments in which the control system is configured to control the energy system such that: at a first operating period, excess energy is used to store energy in the fast-responding electrical storage system and/or the thermal energy storage system, wherein the thermal energy storage system stores hot thermal energy in the first reservoir and cryogenic fluid in the second reservoir; and at a second operating period, electrical energy stored in the fast-responding electrical storage system is discharged prior to, subsequent to, or in conjunction with the thermal energy stored in the thermal energy storage system. Any of the foregoing fourth embodiments can be varied to form additional fourth embodiments in which, during the second operating period, electrical energy stored in the fast-responding electrical storage system is discharged. Any of the foregoing fourth embodiments can be varied to form additional fourth embodiments in which, during the second operating period, energy stored in the thermal energy storage system is discharged. Any of the foregoing fourth embodiments can be varied to form additional fourth embodiments in which the control system is configured to control the energy system such that: at a third operating period, energy generated from the said renewable power generation system is dispatched to the electrical grid or stored in the fast-responding electrical storage system and/or the thermal energy storage system; and at a fourth operating period, energy generated from the said renewable power generating system is directed to store energy in the fast-responding electrical storage system and/or the thermal energy storage system. Any of the foregoing fourth embodiments can be varied to form additional fourth embodiments in which the control system is configured to control the energy system such that: at a fifth operating period, only energy generated from the said renewable power generating system is dispatched to the electrical grid; and at a sixth operating period, both energy generated from the said renewable power generating system and energy stored in the said thermal energy storage system are dispatched on the electrical grid. Any of the foregoing fourth embodiments can be varied to form additional fourth embodiments in which the control system is configured to control the energy system such that: when energy that is designated to be stored is obtained throughout a long period of time, the energy is stored within the thermal energy storage system; and when energy that is designated to be stored is obtained throughout a short period of time, the energy is stored within the fast-responding electrical storage system. Any of the foregoing fourth embodiments can be varied to form additional fourth embodiments in which the control system is configured to control the energy system such that: when the capacity of energy to be stored is large, the large capacity of energy is stored within the thermal energy storage system; and when the capacity of energy to be stored is small, the small capacity of energy is stored within the fast-responding electrical storage system. Any of the foregoing fourth embodiments can be varied to form additional fourth embodiments in which the control system is configured to control the energy system such that: when energy is designated to be dispatched over a long period of time, the energy is discharged within the thermal energy storage system; and when energy is designated to be dispatched over a short period of time, the energy is discharged within the fast-responding electrical storage system. Any of the foregoing fourth embodiments can be varied to form additional fourth embodiments in which the control system is configured to control the energy system such that: when large capacities of energy are to be dispatched, the energy is stored within the thermal energy storage system; and when small capacities of energy are to be dispatched, the energy is stored within the fast-responding electrical storage system. Any of the foregoing fourth embodiments can be varied to form additional fourth embodiments in which the storage capacity of the thermal energy storage system is configured to store a predetermined capacity that is based on the total energy capacity that is generated throughout the weekend from the said renewable power generation system. Any of the foregoing fourth embodiments can be varied to form additional fourth embodiments in which the stored energy in the thermal energy storage system that was stored throughout the weekend from the said renewable power generation system is dispatched during the weekdays. Any of the foregoing fourth embodiments can be varied to form additional fourth embodiments in which the available storage capacity of the system throughout the weekdays is utilized to consume and store excess energy from the electrical grid. Any of the foregoing fourth embodiments can be varied to form additional fourth embodiments in which the control system is configured to control the energy system such that: at a seventh period of time, said fast-responding electrical storage system responds to high frequency intermittent energy that is generated by said renewable power generation system alone or in conjunction with said thermal energy storage system; and at a eighth period of time, said thermal energy storage system responds to low frequency intermittent energy that is generated by the said renewable power generation system alone or in conjunction with said fast-responding electrical storage system; and the system dispatches energy in a highly regulated stream. Any of the foregoing fourth embodiments can be varied to form additional fourth embodiments in which the system draws down and stores energy that originates from at least one of said renewable power generation system and said electrical grid sources. Any of the foregoing fourth embodiments can be varied to form additional fourth embodiments in which the control system is configured to control the energy system such that: stored energy and is transferred from at least one storage system to at least one second storage system or vice versa; wherein the control system receives commands to shift said stored energy from at least one of a sensor signal, algorithm calculation, and scheduled command.

According to fifth embodiments thereof, a system for delivering electricity from an electrical production and storage site is disclosed. In fifth embodiments, the system can include a power supply plant with a storage system including a first storage component configured to store power from a grid and deliver power to the grid at first load and capacity tracking rates. In fifth embodiments, the system can include the power supply plant storage system including a second storage component configured to store power from a grid and deliver power to the grid at second load and capacity tracking rates that are slower than the first load and capacity tracking rates. In fifth embodiments, the system can include a first power generation element whose output capacity is limited and variable. In fifth embodiments, the system can include a second power generation element whose output capacity is selectable at will. In fifth embodiments, the system can include a processor-based programmable control system with memory and connected to sensors adapted for receiving signals indicating a current net demand or excess capacity of the grid and further to detect a rate of change of said net demand or excess capacity and generate command signals responsively to said detecting, the controller being configured to store data representing a time rate of change of said net demand or excess capacity. In fifth embodiments, the control system can be programmed to predict, responsively to the stored data representing a time rate of change of said net demand or excess capacity and further data that represents a model of the grid, a future schedule of electrical power demand and supply of the grid. In fifth embodiments, the control system can be programmed to control, responsively to said stored data, a rate of storage or delivery to or from the first storage component and to or from the second storage component where the rate and quantity of electrical power to store or deliver from the first storage component and the second storage component are independent of each other; and a rate of supply from the first and second power generation elements.

Any of the foregoing fifth embodiments can be varied to form additional fifth embodiments in which the first power plant includes a renewable energy system. Any of the foregoing fifth embodiments can be varied to form additional fifth embodiments in which the first power plant includes at least one of a PV plant, wind plant. Any of the foregoing fifth embodiments can be varied to form additional fifth embodiments in which the second storage system includes a thermal energy storage element. Any of the foregoing fifth embodiments can be varied to form additional fifth embodiments in which the second storage system includes a liquid air energy storage element. Any of the foregoing fifth embodiments can be varied to form additional fifth embodiments in which the second storage system includes a thermal energy storage element. Any of the foregoing fifth embodiments can be varied to form additional fifth embodiments in which the second storage system includes a liquid air energy storage element. Any of the foregoing fifth embodiments can be varied to form additional fifth embodiments in which the second storage system includes a thermal energy storage element and a liquid air energy storage element. Any of the foregoing fifth embodiments can be varied to form additional fifth embodiments in which the second storage system includes a liquid air energy storage element. Any of the foregoing fifth embodiments can be varied to form additional fifth embodiments in which the first storage system includes an electrical energy storage element. Any of the foregoing fifth embodiments can be varied to form additional fifth embodiments in which the electrical energy storage element includes one of a battery, a supercapacitor, a compressed air energy storage device, a hydropumping device, and a flywheel energy storage.

Any of the foregoing first embodiments can be varied to form additional first embodiments in which in all the elements are located at a single site. Any of the foregoing second embodiments can be varied to form additional second embodiments in which in all the elements are located at a single site. Any of the foregoing third embodiments can be varied to form additional third embodiments in which in all the elements are located at a single site. Any of the foregoing fourth embodiments can be varied to form additional fourth embodiments in which in all the elements are located at a single site. Any of the foregoing fifth embodiments can be varied to form additional fifth embodiments in which in all the elements are located at a single site.\

Any of the foregoing first embodiments can be varied to form additional first embodiments in which in all the recited elements thereof are parts of a single plant to permit high speed mechanical and signal communication between the elements. Any of the foregoing fifth embodiments can be varied to form additional fifth embodiments in which in all the recited elements thereof are parts of a single plant to permit high speed mechanical and signal communication between the elements.

It will be appreciated that the modules, processes, systems, and sections described above can be implemented in hardware, hardware programmed by software, software instruction stored on a non-transitory computer readable medium or a combination of the above. For example, a method for controlling energy systems can be implemented, for example, using a processor configured to execute a sequence of programmed instructions stored on a non-transitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, LabVIEW, or another structured or object-oriented programming language. The sequence of programmed instructions and data associated therewith can be stored in a non-transitory computer-readable medium such as a computer memory or storage device which may be any suitable memory apparatus, such as, but not limited to read-only memory (ROM), programmable read-only memory (PROM), electrically erasable programmable read-only memory (EEPROM), random-access memory (RAM), flash memory, disk drive and the like.

Furthermore, the modules, processes, systems, and sections can be implemented as a single processor or as a distributed processor. Further, it should be appreciated that the steps mentioned above may be performed on a single or distributed processor (single and/or multi-core). Also, the processes, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the method, system, or a computer program product (software program stored on a non-transitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of energy processing and storage and/or computer programming arts.

Moreover, embodiments of the disclosed method, system, and computer program product can be implemented in software executed on a programmed general purpose computer, a special purpose computer, a microprocessor, or the like.

It is, thus, apparent that there is provided, in accordance with the present disclosure, Energy Processing and Storage. Many alternatives, modifications, and variations are enabled by the present disclosure. Features of the disclosed embodiments can be combined, rearranged, omitted, etc., within the scope of the invention to produce additional embodiments. Furthermore, certain features may sometimes be used to advantage without a corresponding use of other features. Accordingly, Applicants intend to embrace all such alternatives, modifications, equivalents, and variations that are within the spirit and scope of the present invention.

1-54. (canceled)

55. A system for delivering electricity from an electrical production and storage site, comprising:
a power supply plant with a storage system including a first storage component configured to store power from a grid and deliver power to the grid at first load and capacity tracking rates;
the power supply plant storage system including a second storage component configured to store power from a grid and deliver power to the grid at second load and capacity tracking rates that are slower than the first load and capacity tracking rates;
a first power generation element whose output capacity is limited and variable;
a second power generation element whose output capacity is selectable at will;
a processor-based programmable control system with memory and connected to sensors adapted for receiving signals indicating a current net demand or excess capacity of the grid and further to detect a rate of change of said net demand or excess capacity and generate command signals responsively to said detecting, the controller being configured to store data representing a time rate of change of said net demand or excess capacity;
the control system being programmed to predict, responsively to the stored data representing a time rate of change of said net demand or excess capacity and further data that represents a model of the grid, a future schedule of electrical power demand and supply of the grid and to control, responsively to said stored data,
a rate of storage or delivery to or from the first storage component and to or from the second storage component where the rate and quantity of electrical power to store or deliver from the first storage component and the second storage component are independent of each other; and
a rate of supply from the first and second power generation elements.

56. The system according to claim 55, wherein the first power generation element includes a renewable energy system.

57. The system according to claim 56, wherein the first power generation element includes at least one of a PV plant, wind plant.

58. The system according to claim 56, wherein the second storage component includes a thermal energy storage element.

59. The system according to claim 56, wherein the second storage component includes a liquid air energy storage element.

60. The system according to claim 55, wherein the second storage component includes a thermal energy storage element.

61. The system according to claim 55, wherein the second storage component includes a liquid air energy storage element.

62. The system according to claim 56, wherein the second storage component includes a thermal energy storage element and a liquid air energy storage element.

63. (canceled)

64. The system of claim 55, wherein the first storage component includes an electrical energy storage element.

65. The system of claim 64, wherein the electrical energy storage element includes one of a battery, a supercapacitor, a compressed air energy storage device, a hydropumping device, and a flywheel energy storage.

66. The system of claim 55, wherein all the elements are located at a single site.

67. The system of claim 55, wherein all the recited elements thereof are parts of a single plant to permit high speed mechanical and signal communication between the elements.

68. A method for delivering electricity from an electrical production and storage site, the method comprising:
at a first storage component of a storage system of a power supply plant, storing power from a grid and delivering power to the grid at first load and capacity tracking rates;
at a second storage component of the storage system, storing power from a grid and delivering power to the grid at second load and capacity tracking rates that are slower than the first load and capacity tracking rates;
receiving, at a processor-based programmable control system of the storage system having memory and being connected to sensors, signals from said sensors indicating a current net demand or excess capacity of the grid;
detecting a rate of change of said net demand or excess capacity and generating command signals responsively to said detecting;
storing data representing a time rate of change of said net demand or excess capacity;
predicting, responsively to the stored data representing a time rate of change of said net demand or excess capacity and further data that represents a model of the grid, a future schedule of electrical power demand and supply of the grid; and
controlling, responsively to said stored data:
a rate of storage or delivery to or from the first storage component and to or from the second storage component where the rate and quantity of electrical power to store or deliver from the first storage component and the second storage component are independent of each other; and
a rate of supply from first and second power generation elements, the first power generation element having output capacity that is limited and variable, the second power generation element having output capacity that is selectable at will.

69. The method according to claim 68, wherein the first power generation element includes a renewable energy system.

70. The method according to claim 69, wherein the first power generation element includes at least one of a PV plant, wind plant.

71. The method according to claim 69, wherein the second storage component includes a thermal energy storage element and/or a liquid air energy storage element.

72. The method according to claim 68, wherein the second storage component includes a thermal energy storage element and/or a liquid air energy storage element.

73. The method according to claim 68, wherein the first storage component includes an electrical energy storage element.

74. The method according to claim 68, wherein the first storage component, the second storage component, the control system, the first power generation element, and the second power generation element are located at a single site.

75. The method according to claim 68, wherein the first storage component, the second storage component, the control system, the first power generation element, and the second power generation element are parts of a single plant to permit high speed mechanical and signal communication between the elements.
